(19) United States
(12) Patent Application Publication
(10) Pub. No.: US 2012/0290935 A1
(43) Pub. Date: Nov. 15, 2012

(54) INFORMATION PROCESSING APPARATUS, SERVER DEVICE, INFORMATION PROCESSING METHOD, COMPUTER PROGRAM, AND CONTENT SHARING SYSTEM

(76) Inventors: Koji IHARA, Chiba (JP); Shingo UTSUKI, Kanagawa (JP); D.Forrest MATTHEW, Kanagawa (JP)

(21) Appl. No.: 13/463,277

(22) Filed: May 3, 2012

(30) Foreign Application Priority Data
May 12, 2011 (JP) 2011-107401

(51) Int. Cl. G06F 3/048

(52) U.S. Cl. 715/733

(57) ABSTRACT

Provided is an information processing apparatus including a script management unit for injecting a script for monitoring an operation, by a user who directly operates content, on content of the user into the content, and communicating with the script injected into the content, and a user operation information transmission unit for receiving details of the user operation detected by the script, and transmitting the details to an external server device. When a cursor position is received from the script as the details of the user operation, the user operation information transmission unit transforms the cursor position that the script has acquired into a cursor position with respect to a reference position on a screen and transmits the cursor position to the server device.

### BACKGROUND

The present disclosure relates to an information processing apparatus, a server device, an information processing method, a computer program, and a content sharing system.

There is a technology of allowing a plurality of users to simultaneously view the same content (for example, a Web page on the Internet) by an application for displaying the content (for example, a Web browser) (for example, see JP 2011-70511A). Taking here the relation between a Web page and a Web browser as an example, when a user selects a link on a Web page or scroll the Web page, this technology causes such an action to be reflected in the Web browser of another user. With this technology, a plurality of users can simultaneously view a Web page in the same manner.

### SUMMARY

A concept of a user who only views the viewing and operation of the same content by a plurality of users is provided by applying this technology. Taking the relation between a Web page and a Web browser as an example, viewing of a Web page is shared in real time among a plurality of Web browsers. In this sharing, in addition to displaying the Web page at the same URL, scrolling and a mouse cursor can also be shared. According to this technology, communication such as a chat between a plurality of users about a popular Web page can be realized by only the Web browser.

However, a Web browser is provided with a mechanism called “Same Origin Policy” for maintaining security. This is for imposing a restriction that prevents access from a Web page in a domain to a Web page in another domain. Thus, the state of viewing (scrolling or mouse cursor manipulation) of an existing Web page which may pop up as a popular topic may not be monitored from a Web page in another domain.

The present disclosure has been made in view of the above circumstances, and intends to provide an information process apparatus, a server device, an information processing method, a computer program, and a content sharing system which are novel and improved, and which are capable of obtaining the same rendering result even under this restriction and even if the window size of an application for displaying content is different among participants in communication and thus accurately sharing display details of content including a mouse cursor among the participants.

According to the present disclosure, there is provided an information processing apparatus which includes a script management unit for injecting a script for monitoring an operation, by a user who directly operates content, on content of the user into the content, and communicating with the script injected into the content, and a user operation information transmission unit for receiving details of the user operation detected by the script, and transmitting the details to an external server device. When a cursor position is received from the script as the details of the user operation, the user operation information transmission unit transforms the cursor position that the script has acquired into a cursor position with respect to a reference position on a screen and transmits the cursor position to the server device.

Furthermore, according to the present disclosure, there is provided information processing apparatus which includes an operation details reception unit for receiving from a server device details of an operation, by a user who directly operates content, on content of the user, and a content display unit for reflecting operation details received by the operation details reception unit in display of content same as the content displayed at a device operated by the user, and performing display.

Furthermore, according to the present disclosure, there is provided a server device which includes an operation details reception unit for receiving from a device monitoring an operation, by a user who directly operates content, on content of the user details of the operation, and an operation details relay unit for transmitting the details of the operation to every device logged in a system except for a transmission source.

Furthermore, according to the present disclosure, there is provided an information processing method which includes injecting a script for monitoring an operation, by a user who directly operates content, on content of the user into the content, and communicating with the script injected into the content, and receiving details of the user operation detected by the script, and transmitting the details to an external server device. In the step of receiving and transmitting, when a cursor position is received from the script as the details of the user operation, the cursor position that the script has acquired is transformed into a cursor position with respect to a reference position on a screen before being transmitted to the server device.

Furthermore, according to the present disclosure, there is provided a computer program for causing a computer to perform injecting a script for monitoring an operation, by a user who directly operates content, on content of the user into the content, and communicating with the script injected into the content, and receiving details of the user operation detected by the script, and transmitting the details to an external server device. In the step of receiving and transmitting, when a cursor position is received from the script as the details of the user operation, the cursor position that the script has acquired is transformed into a cursor position with respect to a reference position on a screen before being transmitted to the server device.

Furthermore, according to the present disclosure, there is provided a content sharing system which includes a plurality of first information processing apparatuses operated by users who directly operate content, at least one second information processing apparatus that is used to view the content that is operated by the first information processing apparatuses, and a server device for relaying between the first information processing apparatuses and the second information processing apparatus. The first information processing apparatuses each include a script management unit for injecting a script for monitoring an operation, by a user who directly operates content, on content of the user into the content, and communicating with the script injected into the content, and a user operation information transmission unit for receiving details of the user operation detected by the script, and transmitting the details to the server device. When a cursor position is received from the script as the details of the user operation, the user operation information transmission unit transforms the cursor position that the script has acquired into a cursor position with respect to a reference position on a screen and transmits the cursor position to the server device. The server device includes an operation details reception unit for receiving from a device monitoring an operation, by a user who directly operates content, on content of the user the operation details, and an operation details relay unit for transmitting the operation details to every device logged in the system except for a transmission source. The second information processing apparatus includes an operation details reception unit for receiving from the server device details of an operation, by a user who directly operates content, on content of the user, and a content display unit for reflecting operation details received by the operation details reception unit in display of content same as the content displayed at a device operated by the user, and performing display.

As described above, according to the present disclosure, there can be provided an information process apparatus, a server device, an information processing method, a computer program, and a content sharing system which are novel and improved, and which are capable of obtaining the same rendering result even if the window size of an application for displaying content is different among participants in communication and thus accurately sharing display details of content including a mouse cursor among the participants.

### BRIEF DESCRIPTION OF THE DRAWINGS

FIG. 1 is an explanatory diagram showing an overall configuration of a content sharing system 1 according to an embodiment of the present disclosure;

FIG. 2 is an explanatory diagram showing an overview of each device configuring a content sharing system 1 according to an embodiment of the present disclosure;

FIG. 3 is an explanatory diagram showing a functional configuration of an information processing apparatus 100a on a player side according to an embodiment of the present disclosure;

FIG. 4 is an explanatory diagram showing a functional configuration of a system server 20 according to an embodiment of the present disclosure;

FIG. 5 is an explanatory diagram showing a functional configuration of an information processing apparatus 200a on an audience side according to an embodiment of the present disclosure;

FIG. 6 is a flow chart showing processes to be performed by a content script 155 and a browser extension application 140;

FIG. 7 is a flow chart showing processes to be performed by a relay server 23;

FIG. 8 is a flow chart showing processes to be performed by a dedicated Web application 240;

FIG. 9 is an explanatory diagram showing an example of a relation between a frame and coordinates of a mouse cursor position;

FIG. 10 is an explanatory diagram showing a relation between a cursor position received from the relay server 23 and a cursor position on the dedicated Web application 240;

FIG. 11 is an explanatory diagram showing rendering processing at the dedicated Web application 240;

FIG. 12 is an explanatory diagram showing a case where a player draws a cursor to be manipulated at the information processing apparatus 100a above an existing Web page 150;

FIG. 13 is a flow chart showing operation of the information processing apparatus 100a on the player side;

FIG. 14 is an explanatory diagram showing a user interface 300 of a Web browser 130 displayed on an information processing apparatus on the player side;

FIG. 15 is an explanatory diagram showing a user interface 300 of the Web browser 130 displayed on an information processing apparatus on the player side;

FIG. 16 is an explanatory diagram showing a user interface 400 of a Web browser 230 displayed on an information processing apparatus on the audience side;

FIG. 17 is an explanatory diagram showing a user interface 400 of the Web browser 230 displayed on an information processing apparatus on the audience side;

FIG. 18 is an explanatory diagram showing a user interface 400 of the Web browser 230 displayed on an information processing apparatus on the audience side;

FIG. 19 is an explanatory diagram showing a user interface 400 of the Web browser 230 displayed on an information processing apparatus on the audience side;

FIG. 20 is an explanatory diagram showing a user interface 400 of the Web browser 230 displayed on an information processing apparatus on the audience side;

FIG. 21 is an explanatory diagram showing a user interface 400 of the Web browser 230 displayed on an information processing apparatus on the audience side;

FIG. 22 is an explanatory diagram showing a user interface 400 of the Web browser 230 displayed on an information processing apparatus on the audience side;

FIG. 23 is an explanatory diagram showing a user interface 400 of the Web browser 230 displayed on an information processing apparatus on the audience side;

FIG. 24 is an explanatory diagram showing an overview of display of comments sent from an audience;

FIG. 25 is an explanatory diagram showing an overview of display of comments sent from an audience;

FIG. 26 is an explanatory diagram showing display of an audience icon in an audience information display area 420;

FIG. 27 is an explanatory diagram showing display of audience icons in the audience information display area 420;

FIG. 28 is an explanatory diagram showing display of audience icons in the audience information display area 420;

FIG. 29 is an explanatory diagram showing display of audience icons in the audience information display area 420;

FIG. 30 is an explanatory diagram showing display of audience icons in the audience information display area 420;

FIG. 31 is an explanatory diagram showing display of audience icons in the audience information display area 420;

FIG. 32 is an explanatory diagram showing display of audience icons in the audience information display area 420;

FIG. 33 is an explanatory diagram showing display of audience icons in the audience information display area 420;

FIG. 34 is an explanatory diagram showing display of audience icons in the audience information display area 420;

FIG. 35 is an explanatory diagram showing an overview of display of comments sent from an audience;

FIG. 36 is an explanatory diagram showing display of an audience icon in the audience information display area 420;

FIG. 37 is an explanatory diagram showing display of audience icons in the audience information display area 420;

FIG. 38 is an explanatory diagram showing display of audience icons in the audience information display area 420;

FIG. 39 is an explanatory diagram showing display of audience icons in the audience information display area 420;

FIG. 40 is an explanatory diagram showing display of audience icons in the audience information display area 420;

FIG. 41 is an explanatory diagram showing display of audience icons in the audience information display area 420;

FIG. 42 is an explanatory diagram showing display of audience icons in the audience information display area 420;

FIG. 43 is an explanatory diagram showing display of audience icons in the audience information display area 420;

FIG. 44 is an explanatory diagram showing display of audience icons in the audience information display area 420;

FIG. 45 is an explanatory diagram showing an overview of display processing of comments from audience members;

FIG. 46 is an explanatory diagram showing a user interface 400 of the Web browser 230 displayed on the information processing apparatus on the audience side;

FIG. 47 is an explanatory diagram showing a user interface 400 of the Web browser 230 displayed on the information processing apparatus on the audience side;

FIG. 48 is an explanatory diagram showing a user interface 400 of the Web browser 230 displayed on the information processing apparatus on the audience side;

FIG. 49 is an explanatory diagram showing a user interface 400 of the Web browser 230 displayed on the information processing apparatus on the audience side;

FIG. 50 is an explanatory diagram showing a user interface 400 of the Web browser 230 displayed on the information processing apparatus on the audience side;

FIG. 51 is an explanatory diagram showing a user interface 400 of the Web browser 230 displayed on the information processing apparatus on the audience side;

FIG. 52 is an explanatory diagram showing an example of an online event that uses a content sharing system 1 according to an embodiment of the present disclosure;

FIG. 53 is an explanatory diagram showing an example of an online event that uses a content sharing system 1 according to an embodiment of the present disclosure; and

FIG. 54 is an explanatory diagram showing an example of an online event that uses a content sharing system 1 according to an embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and configuration are denoted with the same reference numerals, and repeated explanation of these structural elements is omitted.

Additionally, an explanation will be given in the following order.

<1. Embodiment of Present Disclosure>

[1-1. Example of Overall Configuration of Content Sharing System]

[1-2. Overview of Each Device]

[1-3. Operation of Each Device]

[1-4. Example User Interface]

<2. Summary>

### 1. Embodiment of Present Disclosure

### 1-1. Example of Overall Configuration of Content Sharing System

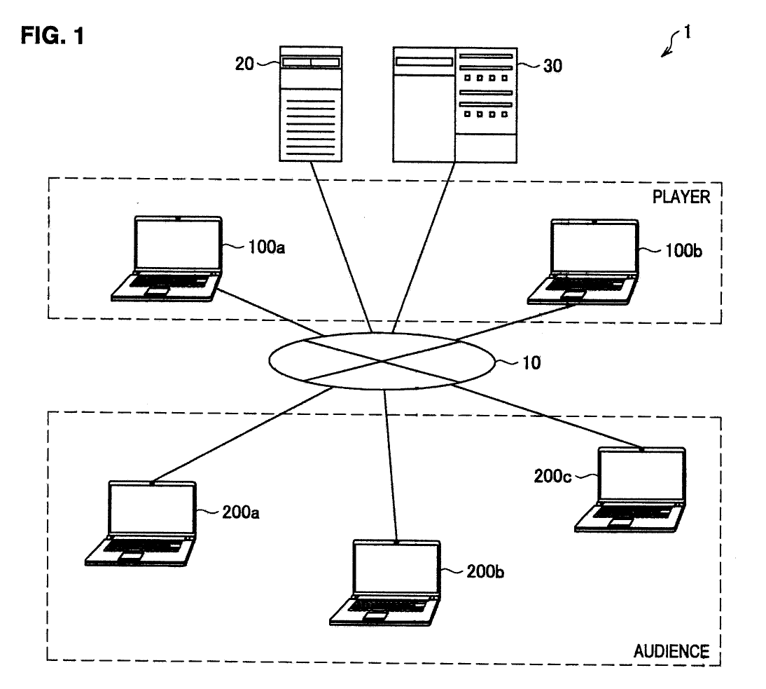

First, an overall configuration of a content sharing system according to an embodiment of the present disclosure will be described. FIG. 1 is an explanatory diagram showing an overall configuration of a content sharing system 1 according to an embodiment of the present disclosure. In the following, an overall configuration of the content sharing system 1 according to an embodiment of the present disclosure will be described using FIG. 1.

The content sharing system 1 according to an embodiment of the present disclosure shown in FIG. 1 is a system that realizes real-time sharing and simultaneous display of one Web page, which is an example of content of the present disclosure, at a plurality of information processing apparatuses. As shown in FIG. 1, the content sharing system 1 according to an embodiment of the present disclosure has a structure where a system server 20, a Web server 30, and information processing apparatuses 100a, 100b, 200a, 200b, and 200c are connected to each other via a network 10.

The information processing apparatuses 100a, 100b, 200a, 200b, and 200c connected to the network 10 can simultaneously display a Web page on the Web server 30. Information processing apparatuses connected to the network 10 are divided into those enabling simultaneous viewing of one Web page and operation of the Web page, and those used, not to operate the Web page that is displayed, but to view the one Web page that is displayed simultaneously with other users. In the following explanation, a user operating the former information processing apparatus will be referred to as a “player,” and a user operating the latter information processing apparatus as an “audience member.” In the present embodiment, the information processing apparatuses 100a and 100b are information processing apparatuses operated by the “players,” and the information processing apparatuses 200a, 200b, and 200c are information processing apparatuses operated by the “audience members.”

The information processing apparatuses 100a and 100b to be operated by the players are used by players operating a shared Web page. In the information processing apparatuses 100a and 100b, Web browsers provided with a browser extension function are working, and a browser extension application dedicated to the content sharing system 1 is installed in the Web browsers. Players perform normal browsing of a Web page by the Web browsers working in the information processing apparatuses 100a and 100b, and the Web page being viewed is shared in real time by the player side and the audience side. The existing Web page that is shared at this time is directly loaded from the Web server 30 providing existing Web pages. Furthermore, if the players speak to microphones provided in the information processing apparatuses 100a and 100b while browsing a Web page, the content of the speech will be output from information processing apparatuses operated by other players and audience members.

The information processing apparatuses 200a, 200b, and 200c to be operated by audience members are used by audience members who only view, at the same time, a Web page that is being operated by a player. Web browsers work in the information processing apparatuses 200a, 200b, and 200c operated by the audience members. An audience member inputs a specific URL using the Web browser, loads a Web application dedicated to this system on the Web browser, and causes a Web page to be displayed. This dedicated Web application displays in real time at the information processing apparatuses 200a, 200b, and 200c operated by the audience members operation of a Web page, being viewed, by a player. The existing Web page that is shared at this time is directly loaded from the Web server 30 providing existing Web pages.

The system server 20 is a server for sharing, and displaying, one Web page among a plurality of information processing apparatuses connected to the network 10. Although the configuration of the system server 20 will be described later, the system server 20 receives details of operations of players from the information processing apparatuses 100a and 100b operated by the players, and transmits the details of the operations of the players to the information processing apparatuses 200a, 200b, and 200c operated by audience members to have them displayed by the information processing apparatuses 200a, 200b, and 200c. Furthermore, the system server 20 also has a Web application server function for providing a dedicated Web application to the information processing apparatuses 200a, 200b, and 200c operated by the audience members. Additionally, the two functions described above may be provided in one appliance as in the present embodiment, or may be provided in separate appliances.

Additionally, FIG. 1 shows two information processing apparatuses that are operated by the players and three information processing apparatuses that are operated by the audience members, but the present technology is not limited to such an example. According to the present technology, the number of information processing apparatuses that are operated by the players may be three or more, as long as there are more than one information processing apparatus, and the number of information processing apparatuses that are operated by the audience members may be one or more. Furthermore, each information processing apparatus may be operated by either the player or the audience member.

Additionally, in FIG. 1, the information processing apparatuses 100a and 100b that are operated by the players and the information processing apparatuses 200a, 200b, and 200c that are operated by the audience members are shown as notebook personal computers, but the present disclosure is not limited to such an example. That is, the technology described below can be applied in the same manner to any of those capable of loading a Web page from the Web server 30 and displaying the Web page.

In the above, an overall configuration of the content sharing system 1 according to an embodiment of the present disclosure has been described using FIG. 1. Next, an overview of each device configuring the content sharing system 1 according to an embodiment of the present disclosure will be given.

### 1-2. Overview of Each Device

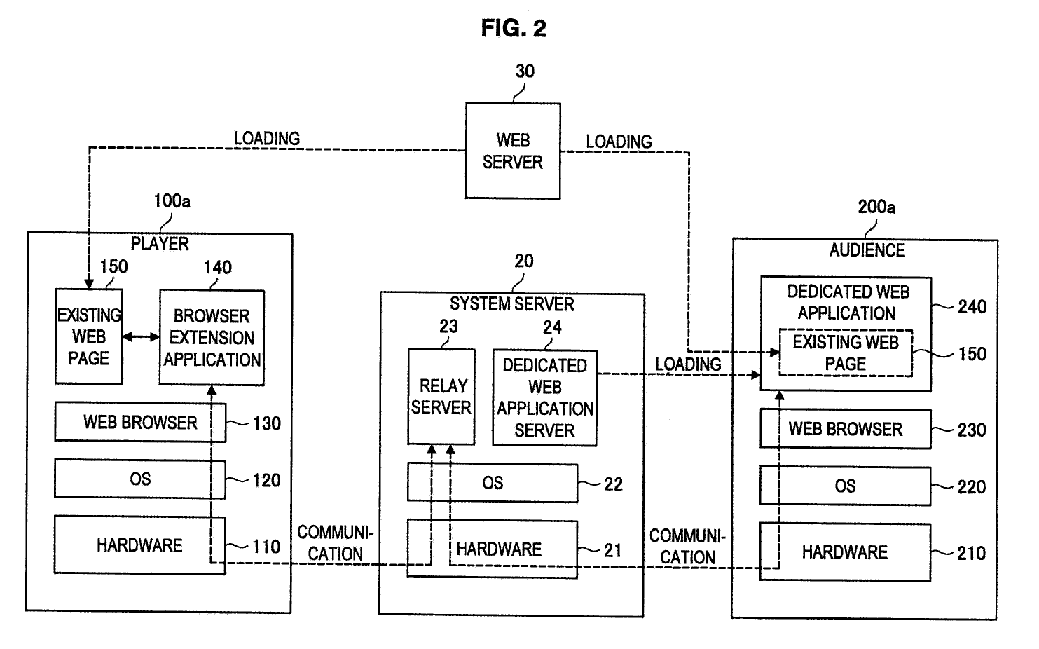

FIG. 2 is an explanatory diagram showing an overview of each device configuring the content sharing system 1 according to an embodiment of the present disclosure. In the following, an overview of each device configuring the content sharing system 1 according to an embodiment of the present disclosure will be given using FIG. 2.

FIG. 2 shows the information processing apparatus 100a as the information processing apparatus to be operated by a player, and the information processing apparatus 200a as the information processing apparatus to be operated by an audience member.

As shown in FIG. 2, the information processing apparatus 100a is configured, including hardware 110 configured from a CPU, a ROM, a RAM, a keyboard, a mouse, a microphone, a speaker, a display and the like, an OS (Operating System) 120 run by the hardware 110, and a Web browser 130 run by the OS 120.

A browser extension application 140 dedicated to the content sharing system 1 is installed in the Web browser 130. The Web browser 130 displays an existing Web page 150 that is directly loaded from the Web server 30 providing existing Web pages.

The browser extension application 140 injects a content script, which is a part thereof, into the existing Web page 150. This content script performs monitoring of an event of a user and acquisition of data that is necessary for sharing, to share one Web page in real time among the information processing apparatuses on the player side and the information processing apparatus on the audience side.

As shown in FIG. 2, the system server 20 is configured, including hardware 21 configured from a CPU, a ROM, a RAM, a keyboard, a mouse, a display and the like, an OS 22 run by the hardware 21, and a relay server 23 and a dedicated Web application server 24 run by the OS 22.

The relay server 23 has a function of relaying messages exchanged between the browser extension application 140 operating on the information processing apparatus 100a on the player side and the dedicated Web application 240 operating on the information processing apparatus 200a on the audience side.

This relay server 23 has two main functions. The first function is to manage the player and the audience member connected to the relay server 23. A player or an audience member establishes a connection to the relay server 23 using a technology such as Comet relying on HTML5 WebSocket or HTML5 XmlHttpRequest. This is because, to transfer in real time a message received from the information processing apparatus 100a on the player side to another player or the information processing apparatus 200a on the audience side, it is important that these connections are managed by a database or the like.

The other function is to transfer information, such as an URL received from the browser extension application 140, a render size, a scroll position, a cursor position and the like, to the dedicated Web application 240 operating on the information processing apparatus 200a on the audience side or a browser extension application of an information processing apparatus other than the information processing apparatus which is the transmission source, registered in the database described above for managing the connection.

The dedicated Web application server 24 stores a dedicated Web application that runs on the information processing apparatus 200a on the audience side. The dedicated Web application server 24 provides, when requested by the information processing apparatus 200a on the audience side, a dedicated Web application stored in the dedicated Web application server 24 to the information processing apparatus 200a. A dedicated Web application is provided from the dedicated Web application server 24 based on an access to a specific URL from a Web browser 230 working on the information processing apparatus 200a.

As shown in FIG. 2, the information processing apparatus 200a is configured, including hardware 210 configured from a CPU, a ROM, a RAM, a keyboard, a mouse, a microphone, a speaker, a display and the like, an OS 220 run by the hardware 210, and a Web browser 230 run by the OS 220.

As described above, when a specific URL is accessed through the Web browser 230 working on the information processing apparatus 200a, a dedicated Web application for sharing in real time a Web page that is being viewed and operated by a player is loaded from the dedicated Web application server 24. The Web browser 230 displays, by the dedicated Web application 240 which has been loaded, an existing Web page 150 that is being viewed and operated by a player, and thereby displays in real time operation, by the player, of the Web page that is being viewed.

With each device configuring the content sharing system 1 according to an embodiment of the present disclosure being configured in this manner, the content of a Web page displayed on the information processing apparatus on the player side is simultaneously displayed on the information processing apparatus on the audience side.

In the foregoing, an overview of each device configuring the content sharing system 1 according to an embodiment of the present disclosure has been given using FIG. 2. Next, a functional configuration of the information processing apparatus on the player side configuring the content sharing system 1 according to an embodiment of the present disclosure will be described.

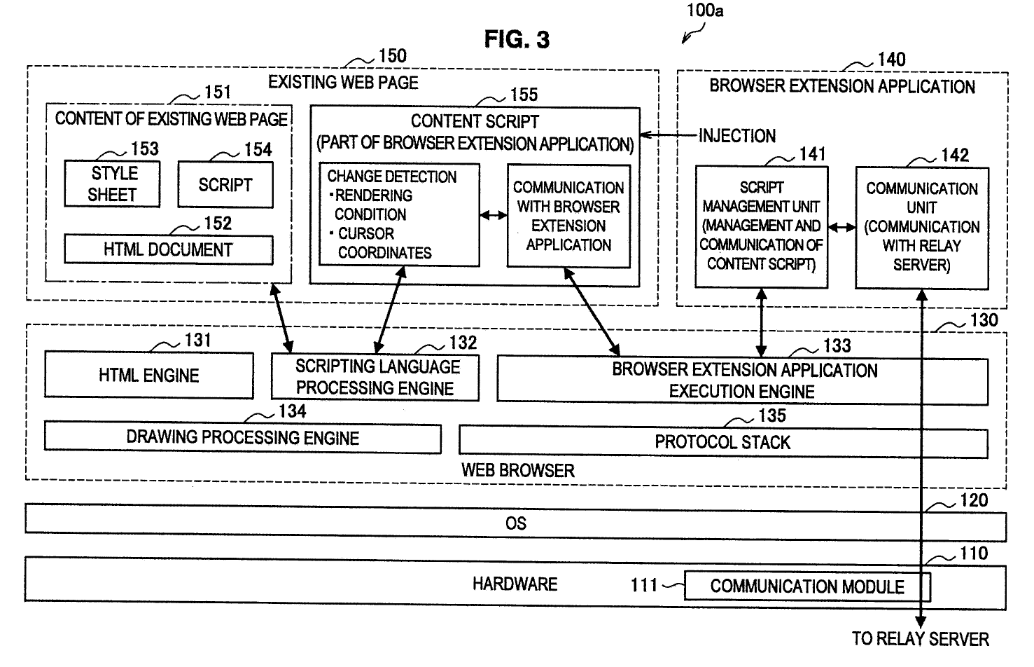

FIG. 3 is an explanatory diagram showing a functional configuration of the information processing apparatus 100a on the player side according to an embodiment of the present disclosure. In the following, a functional configuration of the information processing apparatus 100a on the player side will be described using FIG. 3.

As described above, the information processing apparatus 100a is configured, including the hardware 110 configured from a CPU, a ROM, a RAM, a keyboard, a mouse, a microphone, a display and the like, the OS 120 run by the hardware 110, and the Web browser 130 run by the OS 120.

The hardware 110 includes a communication module 111. The communication module 111 carries out the communication between the browser extension application 140 described below and the relay server 23. The OS 120 is software that provides basic functions that are commonly used by a plurality of pieces of application software, including input/output functions, such as keyboard input by a user and screen output, and a management function of a disk or a memory, and that manages the information processing apparatus 100a.

The Web browser 130 is software for displaying a Web page, which is run by the OS 120. The Web browser 130 is configured, including an HTML engine 131, a scripting language processing engine 132, a browser extension application execution engine 133, a drawing processing engine 134, and a protocol stack 135.

The HTML engine 131 analyses, with respect to an existing Web page 150 sent from the Web server 30 and written in HTML language, the HTML language sent from the Web server 30. When the HTML language written in the existing Web page 150 is analysed by the HTML engine 131, the analysis result is output by the drawing processing engine 134 as an image. The existing Web page 150 sent from the Web server 30 includes content 151 of the existing Web page. The content 151 of the existing Web page is configured, including an HTML document 152 describing the details of the content, a style sheet 153 defining the layout of the content, and a script 154 defining the operation of the content.

The scripting language processing engine 132 interprets the scripting language embedded in a Web page sent from the Web server 30 and written in the HTML language, and executes the script. According to the present embodiment, the scripting language processing engine 132 interprets the details of a content script 155 embedded, by the browser extension application 140 that is installed in the Web browser 130, in a Web page sent from the Web server 30, and executes the script.

The browser extension application execution engine 133 runs the browser extension application 140 that is installed in the Web browser 130. According to the present embodiment, the browser extension application execution engine 133 performs exchange of data between the content script 155 and the browser extension application 140. The browser extension application 140 is installed in the information processing apparatus 100a by the Web browser 130 accessing a predetermined URL, for example, and is run together with the Web browser 130 at the time of execution of the Web browser 130.

The drawing processing engine 134 performs a drawing process for outputting an image based on an analysis result by the HTML engine 131 of a Web page written in HTML language. The protocol stack 135 is a group of pieces of software for providing a network function, and the Web browser 130 can, for example, acquire a Web page from the Web server 30 or transmit the status of the Web browser 130 to the relay server 23, by the protocol stack 135.

To share in real time a Web page that a player is viewing at the information processing apparatus 100a on the player side, the viewing status of the Web page by the player has to be monitored at all times, and data necessary for sharing has to be transmitted to the relay server 23 according to the change in the status. Pieces of data necessary for sharing are the following four types.

(1) URL of the Web page being viewed
(2) Render size of the entire Web page being viewed
(3) Scroll position of the Web page being viewed
(4) Position of a mouse cursor with respect to the upper left corner of the rendering area of the entire Web page

Many of these pieces of data can be accessed only through an existing Web page that is being viewed using the Web browser 130. Thus, to monitor/acquire these pieces of data, a program dedicated to this system has to be able to access the existing Web page 150. However, normally, a Web browser is provided with a mechanism called “Same Origin Policy” for maintaining security. This mechanism is for preventing access from a Web page in a domain to a Web page in another domain.

Thus, the content sharing system 1 according to the present embodiment uses the extension function of the Web browser 130 to overcome the limitations posed by the security. That is, the browser extension application 140 operating within the framework of the extension function of the Web browser 130 monitors the existing Web page 150, acquires the data necessary for sharing, and transmits the data to the relay server 23. In reality, the browser extension application 140 does not directly monitors the existing Web page 150, but instead, injects the content script 155, which is a part of the browser extension application 140, into the existing Web page 150. Then, this content script 155 monitors the operation of the player, and acquires the data necessary for sharing with another player or audience member.

The browser extension application 140 includes a script management unit 141 and a communication unit 142. Together with injecting into an existing Web page 150 a content script 155 for monitoring an operation, by a player who directly operates existing Web pages 150 displayed by the Web browser 130, on the existing Web page 150 of the player, the script management unit 141 communicates with the content script 155 injected into the existing Web page 150, via the browser extension application execution engine 133. The communication unit 142 receives the details of the operation by the player detected by the content script 155, and transmits the details to the relay server 23 via the communication module 111.

In the foregoing, a functional configuration of the information processing apparatus 100a on the player side, configuring the content sharing system 1 according to an embodiment of the present disclosure, has been described using FIG. 3. Next, a functional configuration of the system server 20 configuring the content sharing system 1 according to an embodiment of the present disclosure will be described.

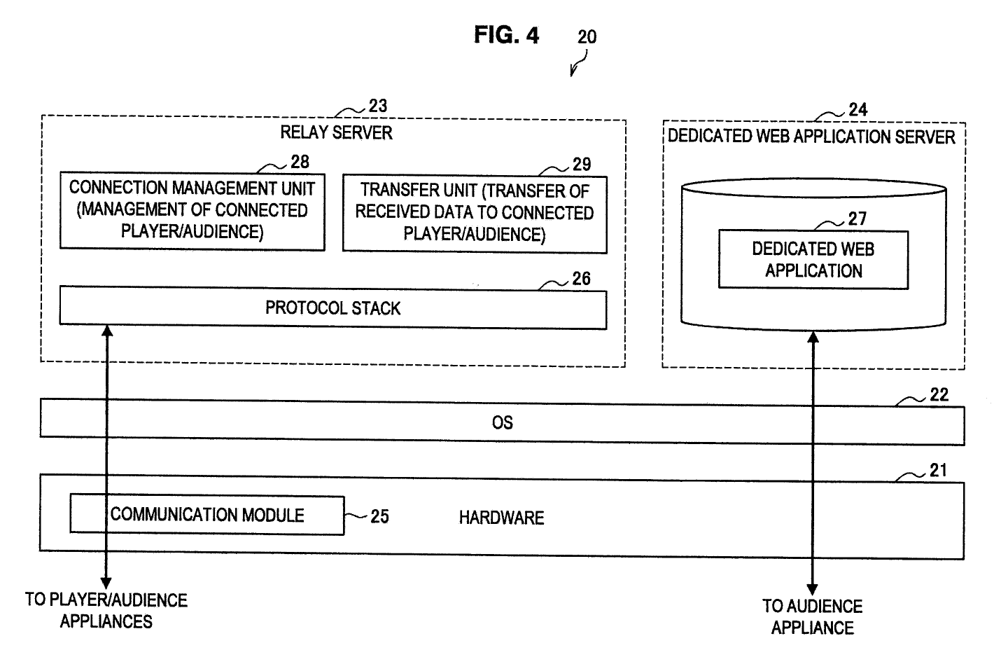

FIG. 4 is an explanatory diagram showing a functional configuration of the system server 20 configuring the content sharing system 1 according to an embodiment of the present disclosure. In the following, a functional configuration of the system server 20 configuring the content sharing system 1 according to an embodiment of the present disclosure will be described using FIG. 4.

As shown in FIG. 4, the system server 20 is configured, including hardware 21 configured from a CPU, a ROM, a RAM, a keyboard, a mouse, a microphone, a display and the like, an OS 22 run by the hardware 21, and a relay server 23 and a dedicated Web application server 24 run by the OS 22.

The hardware 21 includes a communication module 25. The communication module 25 carries out the communication between the relay server 23 and the browser extension application 140 run by the information processing apparatus 100a, and the communication between the relay server 23 and the dedicated Web application 240 run by the information processing apparatus 200a.

The relay server 23 that performs exchange of messages exchanged between the browser extension application 140 of the information processing apparatus 100a, which is an appliance on the player side, and the dedicated Web application 240 of the information processing apparatus 200a, which is an appliance on the audience side, includes a connection management unit 28 and a transfer unit 29. The connection management unit 28 manages the player and the audience member connected to the relay server 23 as described above. The transfer unit 29 transfers the URL of an existing Web page being viewed, the render size, the scroll position or the cursor position, as described above, received from the browser extension application 140 to the dedicated Web application 240 registered in the relay server 23 or the browser extension application 140 other than the transmission source.

As described above, the dedicated Web application server 24 stores a dedicated Web application operating on the information processing apparatus 200a on the audience side. A dedicated Web application is provided from the dedicated

Web application server 24 based on an access to a specific URL from the Web browser 230 working on the information processing apparatus 200a.

In the foregoing, a functional configuration of the system server 20 configuring the content sharing system 1 according to an embodiment of the present disclosure has been described using FIG. 4. Next, a functional configuration of the information processing apparatus 200a on the audience side, configuring the content sharing system 1 according to an embodiment of the present disclosure will be described.

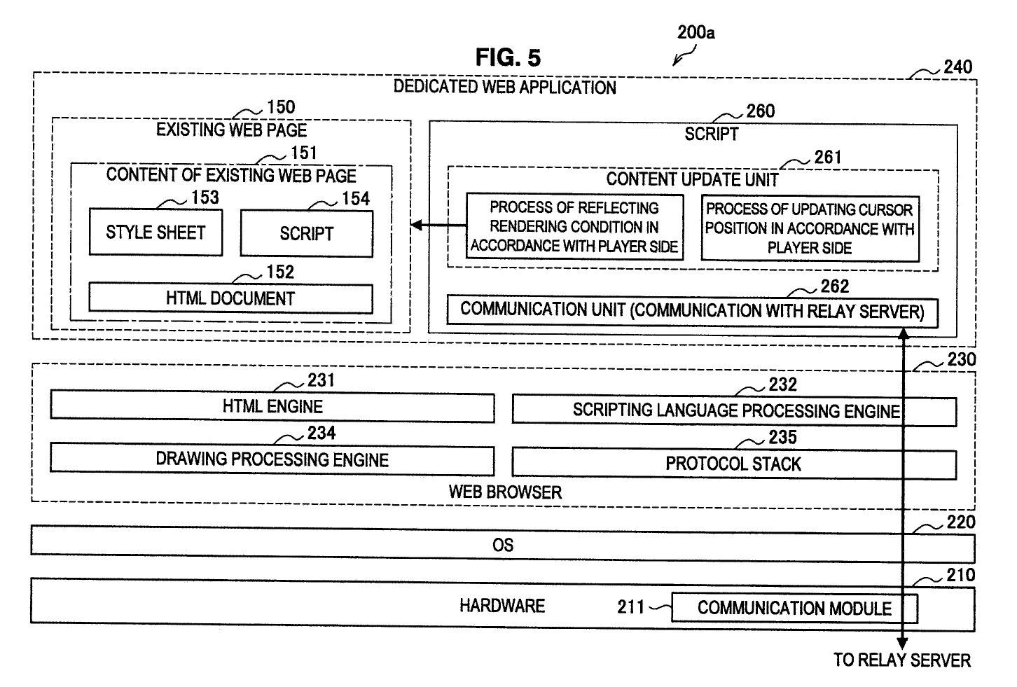

FIG. 5 is an explanatory diagram showing a functional configuration of the information processing apparatus 200a on the audience side, configuring the content sharing system 1 according to an embodiment of the present disclosure.

As shown in FIG. 5, the information processing apparatus 200a on the audience side is configured, including hardware 210 configured from a CPU, a ROM, a RAM, a keyboard, a mouse, a microphone, a display and the like, an OS 220 run by the hardware 210, and a Web browser 230 run by the OS 220.

The hardware 210 includes a communication module 211. The communication module 211 carries out the communication between the dedicated Web application 240 described below and the relay server 23. The OS 220 is software that provides basic functions commonly used by a plurality of pieces of application software, including input/output functions, such as a keyboard input by a user and screen output, and a management function of a disk or a memory, and that manages the information processing apparatus 200a.

The Web browser 230 is software for displaying a Web page, which is run by the OS 220. The Web browser 230 is configured, including an HTML engine 231, a scripting language processing engine 232, a drawing processing engine 234, and a protocol stack 235.

The HTML engine 231 analyses, with respect to an existing Web page 150 sent from the Web server 30 and written in HTML language, the HTML language which has been sent. When the HTML language is analysed by the HTML engine 231, the analysis result is output by the drawing processing engine 234 as an image. The existing Web page 150 sent from the Web server 30 includes content 151 of the existing Web page. The content 151 of the existing Web page is configured, including an HTML document 152 describing the details of the content, a style sheet 153 defining the layout of the content, and a script 154 defining the operation of the content.

The scripting language processing engine 232 interprets the scripting language embedded in a Web page sent from the Web server 30 and written in the HTML language, and executes the script. According to the present embodiment, the scripting language processing engine 232 interprets details content of a content script 155 of the existing Web page 150 sent from the Web server 30, and executes the process written in the content script 155.

The drawing processing engine 234 performs a drawing process for outputting an image based on an analysis result by the HTML engine 231 of a Web page written in HTML language. The protocol stack 235 is a group of pieces of software for providing a network function, and the Web browser 230 can, for example, acquire a Web page from the Web server 30 or carry out the communication between the relay server 23 and the dedicated Web application 240, by the protocol stack 235.

To share a Web page in real time between the player side and the audience side, the information processing apparatus 200a on the audience side acquires the dedicated Web application 240 operating on the Web browser 230 from the dedicated Web application server 24. The dedicated Web application 240 can display the status of viewing or operation of the existing Web page 150 by a player, but does not accept an operation on the Web page by an audience member.

The dedicated Web application 240 is configured, including a script 260 for displaying in real time, on the information processing apparatus 200a, the status of viewing or operation on the existing Web page 150 by a player. The script 260 carries out the communication with the relay server 23, and shares in real time, on the information processing apparatus 200a, a Web page that a player is viewing on the information processing apparatus 100a on the player side.

The script 260 is included in the dedicated Web application 240, and carries out the communication with the relay server 23 and performs, using the information obtained by the communication, a process of reflecting the condition of rendering and a process of updating the cursor position that are in accordance with the information processing apparatus 100a on the player side. With the script 260 performing the process of reflecting the condition of rendering and the process of updating the cursor position that are in accordance with the information processing apparatus 100a on the player side, the information processing apparatus 200a on the audience side is enabled to display, in the same way as on the player side, the image of the existing Web page that the player is operating.

The script 260 includes a content update unit 261 and a communication unit 262. The communication unit 262 receives from the relay server 23 details of an operation, by a player who directly operates existing Web pages 150, on the existing Web page 150 of the player. The content update unit 261 causes the details of the operation by the player received by the communication unit 262 to be reflected in the display of the existing Web page 150 that is the same as the existing Web page 150 displayed on the information processing apparatus on the player side.

In the foregoing, a functional configuration of the information processing apparatus 200a on the audience side, configuring the content sharing system 1 according to an embodiment of the present disclosure has been described. Next, operation of each device configuring the content sharing system 1 according to an embodiment of the present disclosure will be described.

### 1-3. Operation of Each Device

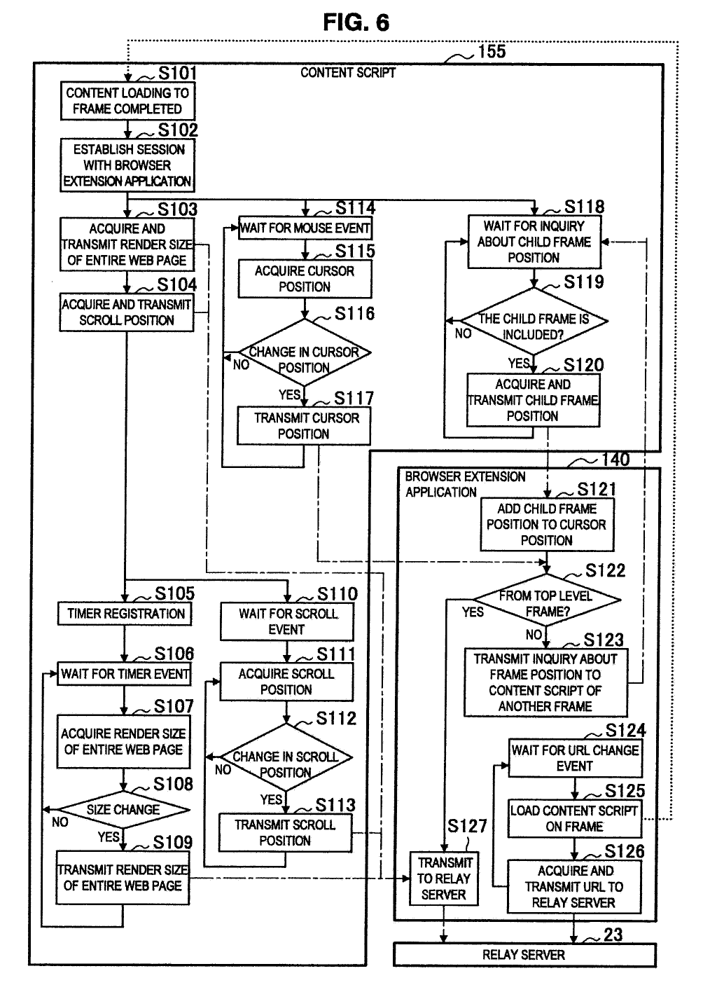

First, an operation of the information processing apparatus 100a on the player side will be described. FIG. 6 is a flow chart showing an operation of the information processing apparatus 100a on the player side, and is a flow chart showing processes to be performed by the content script 155 and the browser extension application 140.

The browser extension application 140 monitors, all the time, a change in the window of a Web browser or, in the case the Web browser is a tabbed browser, the URL of the tab that is displayed. Then, when a URL change event is detected (step S124), information on the new URL is transmitted to the relay server 23 (step S126), and also, a content script 155 is injected into the newly loaded existing Web page 150 (step S125). In the case the existing Web page 150 includes child frames, the content script 155 is also injected into the existing Web page loaded on each child frame.

When the loading of content on the existing Web page 150 is complete (step S101) and the browser extension application 140 injects the content script 155 into the existing Web page 150, the content script 155 which has been loaded first establishes a session with the browser extension application 140 (step S102), and starts monitoring the mouse cursor position or starts waiting for an inquiry about the position of the child frame. Monitoring of the mouse cursor position is realized by monitoring a mousemove event of a document object by JavaScript (registered trademark) in the following manner, for example.

```
document.addEventListener(‘mousemove’, function(event){
  var x_cursor = event.pageX;
  var y_cursor = event.pageY;
  }, true);
```

If the loading destination of a page is a top level frame, the content script 155 acquires the render size of the entire Web page and the scroll position, and transmits the same to the relay server 23 via the browser extension application 140 (steps S103, S104, S127). Also, the content script 155 starts monitoring of the render size of the entire Web page and the scroll position. Monitoring of the render size of the entire Web page by the content script 155 is realized by a resize event of a window object or a check performed at the timing of a timer event that is regularly executed.

To monitor a change in the render size by a timer, the content script 155 performs timer registration (step S105), waits for a timer event (step S106), and acquires the render size of the entire Web page (step S107). The content script 155 determines whether there is a change in the size (step S108), and in the case there is a change in the size, the content script 155 transmits the render size of the entire Web page to the relay server 23 via the browser extension application 140 (steps S109, S127). Acquisition of the render size of the entire Web page is realized by the following script, for example.

```
width = Math.max.apply(null, [
  document.body.clientWidth,
  document.body.scrollWidth,
  document.documentElement.scrollWidth,
  document.documentElement.clientWidth
]);
height = Math.max.apply(null, [
  document.body.clientHeight,
  document.body.scrollHeight,
  document.documentElement.scrollHeight,
  document.documentElement.clientHeight
]);
```

The content script 155 waits for occurrence of a scroll event (step S110), and if a scroll event occurs, acquires the scroll position (step S111). After acquiring the scroll position, the content script 155 determines whether the scroll position has been changed (step S112), and if the scroll position has been changed, transmits the scroll position to the relay server 23 via the browser extension application 140 (steps S113, S127). Monitoring of the scroll position is realized by monitoring the scroll event of a document object by the following script, for example.

```
document.addEventListener(‘scroll’, function(event){
  var scrollLeft = document.body.scrollLeft;
  var scrollTop = document.body.scrollTop;
}, true);
```

Furthermore, the content script 155 waits for occurrence of a mouse event (step S114), and if a mouse event occurs, acquires the cursor position (step S115). After acquiring the cursor position, the content script 155 determines whether the cursor position has been changed (step S116), and if the cursor position has been changed, transmits the cursor position to the relay server 23 via the browser extension application 140 (step S117).

The content script 155 monitors the render size of the entire Web page, the scroll position, and the mouse cursor position. Then, if a change in these pieces of information is detected, the content script 155 acquires each value, and transmits the value acquired to the browser extension application 140.

The browser extension application 140 transmits the render size of the entire Web page and the scroll position received from the content script 155 to the relay server 23 as they are. However, a coordinate transformation process may have to be performed on the mouse cursor position received from the content script 155 before the mouse cursor position is transmitted to the relay server 23. This is because, in the case information on the mouse cursor position is received from the content script 155 that is embedded not in the top level frame, but in the child frame, the mouse cursor position is represented by the coordinates with respect to the upper left corner of the child frame and not by the coordinates with respect to the upper left corner of the top frame level.

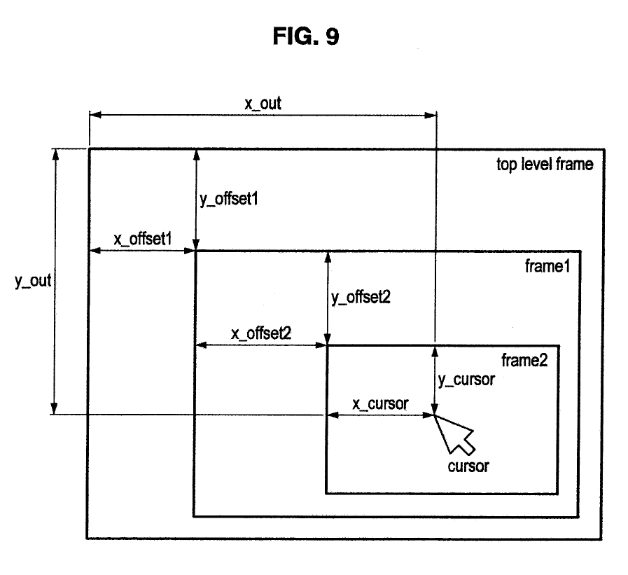

FIG. 9 is an explanatory diagram showing an example of a relation between a frame and the coordinates of the mouse cursor position. As shown in FIG. 9, when the mouse cursor moves on a frame “frame2,” the mouse cursor position that is received from the content script 155 of the frame “frame2” is (x_cursor, y_cursor). To transform this into coordinates (x_out, y_out) with respect to the upper left corner of the top level frame, the browser extension application 140 acquires an offset position (x_offset2, y_offset2) of the frame “frame2” within a frame “frame1” and an offset position (x_offset1, y_offset1) of the frame “frame2” within the top level frame of the frame “frame1,” and adds them to the mouse cursor position (x_cursor, y_cursor) from the content script 155 of the frame “frame2.” The offset position of each child frame can be accessed only from the Web page loaded on the parent frame. Thus, the browser extension application 140 inquires the content script 155 of the parent frame about the offset position using a frame name or the URL of a frame as a key.

The browser extension application 140 determines whether the information on the cursor position transmitted from the content script 155 is from the top level frame (step S122). If it is from the top level frame, the browser extension application 140 transmits the information on the cursor position to the relay server 23 (step S127), but if it is not from the top level frame, the browser extension application 140 transmits the inquiry about the frame position to the content script 155 of another frame (step S123).

The content script 155 waits for an inquiry, from the browser extension application 140, about the position of a child frame (step S118), determines whether the child frame is included (step S119), and if the child frame is included, acquires the offset position of the child frame and transmits the same to the browser extension application 140 (step S120). The browser extension application 140, which has received the information on the offset position of the child frame from the content script 155, adds the offset position of the child frame to the cursor position (step S121).

By repeating the acquisition of the cursor position and the acquisition of the offset position of the child frame until the top level frame is reached, the information on the cursor position acquired by the content script 155 in step S115 described above is transformed into the cursor position of the top level frame.

Additionally, to enable identification of which player's operation an operation is, the browser extension application 140 adds information that allows unique identification of a player (for example, a login ID for the system or the like) to data that is to be transmitted to the relay server 23.

In the foregoing, an operation of the information processing apparatus 100a on the player side has been described. Next, an operation of the relay server 23 will be described.

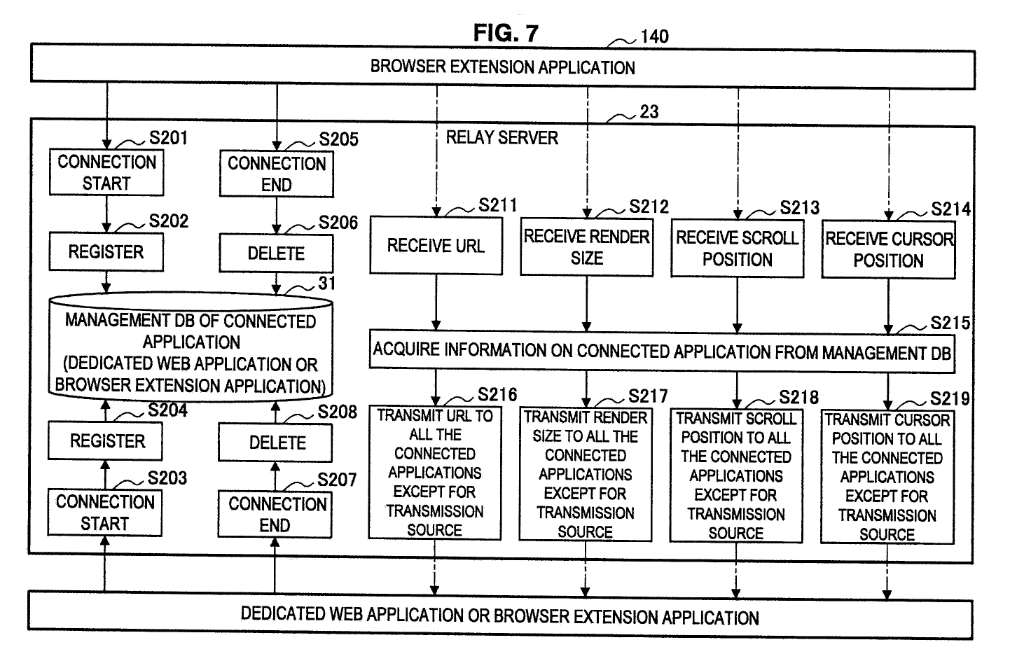

FIG. 7 is a flow chart showing an operation of the relay server 23. In the following, an operation of relay server 23 will be described using FIG. 7.

The relay server 23 plays a role of registering and managing the player and the audience member, and of transmitting information on a URL, a render size, a scroll position, and a cursor position transmitted from the information processing apparatus on the player side to the information processing apparatus other than the transmission source.

When registration in the content sharing system 1 is requested by the browser extension application 140 on the player side, and connection between the browser extension application 140 and the relay server 23 is started (step S201), the relay server 23 registers information on the browser extension application 140 in a management database 31 (step S202). Likewise, when registration in the content sharing system 1 is requested by the dedicated Web application 240 on the audience side, and connection between the dedicated Web application 240 and the relay server 23 is started (step S203), the relay server 23 registers information on the dedicated Web application 240 in the management database 31 (step S204).

On the other hand, when the connection between the browser extension application 140 and the relay server 23 is ended (step S205), the relay server 23 deletes the information on the browser extension application 140 from the management database 31 (step S206). Likewise, when the connection between the dedicated Web application 240 on the audience side and the relay server 23 is ended (step S207), the relay server 23 deletes the information on the dedicated Web application 240 from the management database 31 (step S208).

When information on the URL (step S211), information on the render size (step S212), information on the scroll position (step S213), and information on the cursor position (step S214) are received from the browser extension application 140 on the player side, the relay server 23 acquires from the management database 31 information on the application that is connected (step S215). Then, the relay server 23 transmits to the application whose information has been acquired the information on the URL (step S216), the information on the render size (step S217), the information on the scroll position (step S218), and the information on the cursor position (step S219).

Here, at the time of transmitting the information on the URL, the information on the render size, the information on the scroll position, and the information on the cursor position, the relay server 23 transmits these pieces of information to all the applications that are connected, except for the transmission source. The details of an operation by one player are thereby reflected in real time in all of the information processing apparatuses on the player side and the audience side.

In the foregoing, an operation of the relay server 23 has been described using FIG. 7. Next, an operation of the information processing apparatus 200a on the audience side will be described.

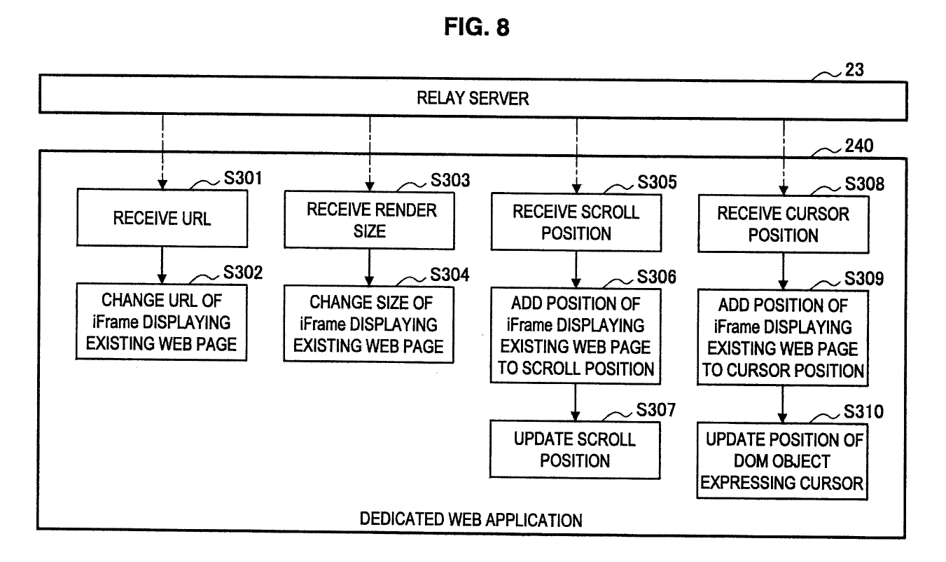

FIG. 8 is a flow chart describing an operation of the information processing apparatus 200a on the audience side, and shows an operation of the dedicated Web application 240. In the following, an operation of the information processing apparatus 200a on the audience side will be described using FIG. 8.

The dedicated Web application 240 operating on the Web browser 230 of the information processing apparatus 200a on the audience side displays in real time, on the information processing apparatus 200a on the audience side, an operation, by a player, of a Web page being viewed by the player. An existing Web page 150 that is shared between the player and the audience member is directly loaded in an iframe within the dedicated Web application 240 from the Web server 30 providing the existing Web page 150. For example, it is assumed, in the present embodiment, that the iframe for an existing Web page is defined as follows.

<iframe id=“shared_page”></iframe>

In the case URL information (url) is received from the relay server 23 (step S301), the dedicated Web application 240 can display the Web page at the URL in the iframe (step S302) if, for example, a process as below is written in JavaScript.

document.getElementById(‘shared_page’).src=url;

Furthermore, for the mouse cursors of the player and the audience member to point to the same position on the existing Web page 150 on the dedicated Web application 240, the results of rendering of the existing Web page 150 have to be the same. Accordingly, by adjusting the size of the iframe for the existing Web page 150 to the render size of the entire existing Web page 150, same rendering result as on the player side can be achieved.

When the render size (width, height) is received from the relay server 23 (step S303), the dedicated Web application 240 can, for example, by writing a process as below in JavaScript, change the size of iframe displaying the existing Web page 150 (step S304), and cause the rendering result of the existing Web page 150 to match that on the player side.

var node = document.getElementById(‘shared_page’);
node.width = width;
node.height = height;

To cause, on the information processing apparatus 200a on the audience side, the display to match the display of the existing Web page 150 on the player side, the existing Web page 150 displayed on the information processing apparatus 200a on the audience side has to be scrolled as appropriate in accordance with a scroll operation performed at the information processing apparatus 100a on the player side.

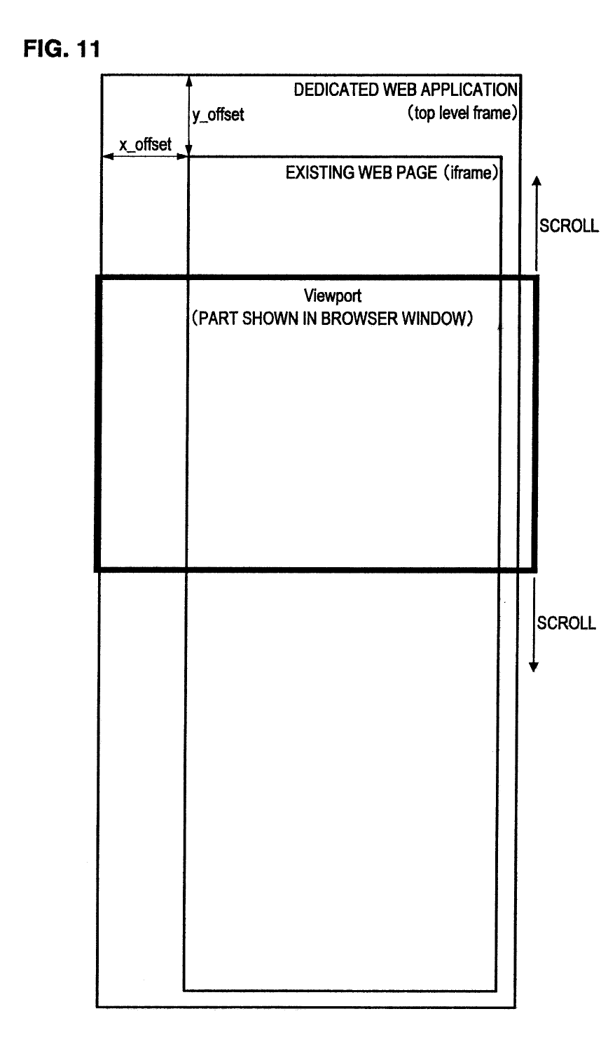

FIG. 11 is an explanatory diagram showing rendering processing at the dedicated Web application 240. As shown in FIG. 11, the existing Web page 150 is rendered in the dedicated Web application 240 in such a way that all of it can be seen. Accordingly, by scrolling the dedicated Web application 240 itself and moving a viewport (a drawing region), the existing Web page 150 is also seen to have been scrolled. In the case the dedicated Web application 240 received the scroll position (left, top) from the relay server 23 (step S305), the dedicated Web application 240 adds the position of the iframe displaying the existing Web page 150 to the scroll position (step S306), and updates the scroll position based on the addition result (step S307). For example, by writing a process as below in JavaScript, the display of the existing Web page 150 can be made to match that on the player side.

window.scrollTo(left+x_offset,top+y_offset);

The cursor that is manipulated by a player on the information processing apparatus 100a is not drawn within the existing Web page 150, but is drawn above the existing Web page 150. In the case the dedicated Web application 240 received a cursor position (x_in, y_in) from the relay server 23 (step S308), the dedicated Web application 240 adds the position of the iframe displaying the existing Web page 150 to the cursor position (step S309), and updates the position of a DOM (Document Object Model) object expressing the cursor based on the addition result (step S310).

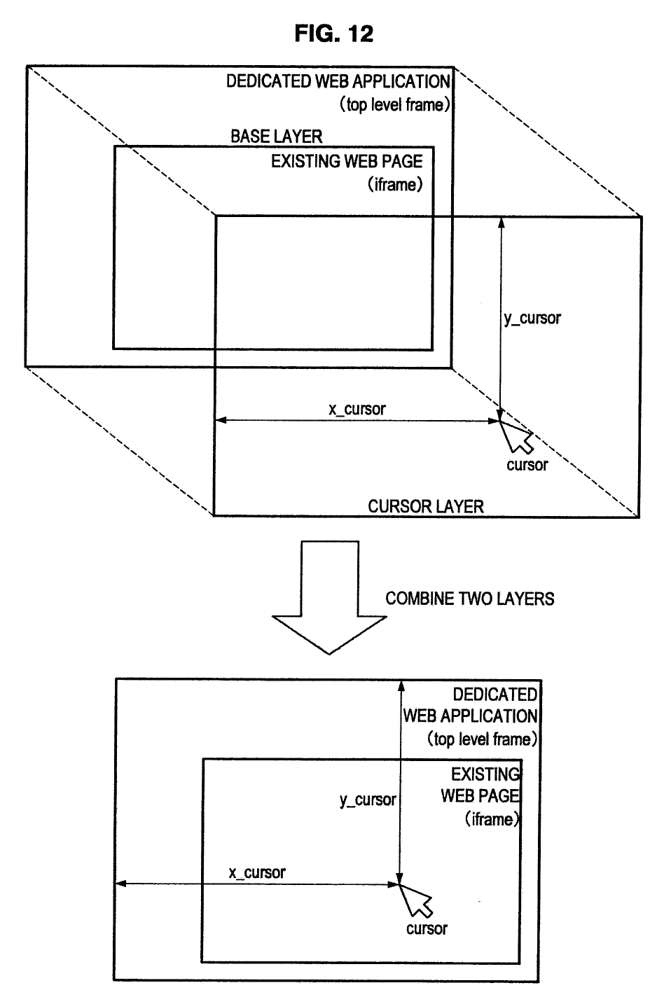

FIG. 12 is an explanatory diagram showing a case where a player draws a cursor to be manipulated at the information processing apparatus 100a above the existing Web page 150. As shown in FIG. 12, by arranging a layer for cursor display above the existing Web page 150 and drawing a cursor on this layer in an overlapping manner, drawing of a cursor, above the existing Web page 150, to be manipulated by the player at the information processing apparatus 100a is expressed.

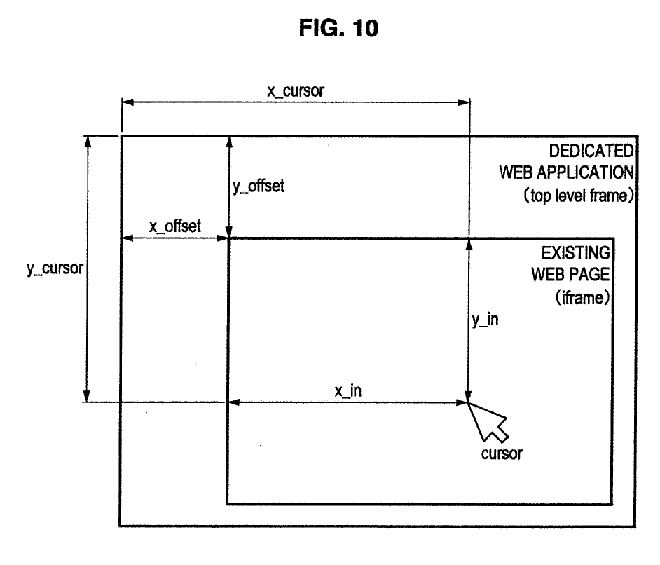

FIG. 10 is an explanatory diagram showing a relation between the cursor position received from the relay server 23 and the cursor position on the dedicated Web application 240. As shown in FIG. 10, the cursor position that the dedicated Web application 240 received from the relay server 23 is coordinates with respect to the upper left corner of the iframe displaying the existing Web page 150. Accordingly, the dedicated Web application 240 draws, on a cursor layer, a cursor that is to be manipulated by the player at the information processing apparatus 100a, after adding the offset of the iframe. The cursor to be manipulated by the player at the information processing apparatus 100a may be drawn by pasting an image of a cursor on the Web browser 230, or may be drawn according to a specification designed to draw a figure on a browser, such as Canvas and the like.

In the foregoing, an operation of the information processing apparatus 200a on the audience side has been described. Next, a display process for a case where there are a plurality of players participating in the content sharing system 1 will be described.

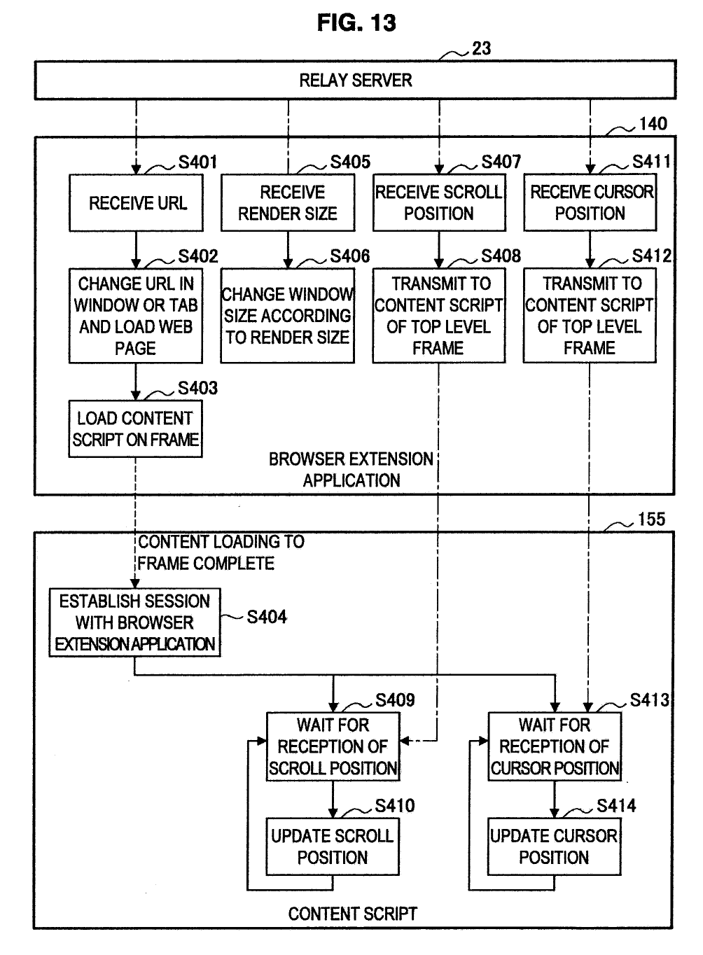

In the case there are a plurality of players that participate in the content sharing system 1, the viewing status of an existing Web page is shared also among the information processing apparatuses on the player side. FIG. 13 is a flow chart showing an operation of the information processing apparatus 100a on the player side, and shows a flow of processing of data necessary for sharing that the content script 155 and the browser extension application 140, executed by the information processing apparatus 100a on the player side, receive via the relay server 23 from the information processing apparatus 100b on the side of another player.

In the case information on a new URL is received from the relay server 23 (step S401), the browser extension application 140 of the information processing apparatus 100a updates the URL to be displayed in the window or tab of the Web browser 130 and loads the new Web page from the Web server 30 (step S402), and also, loads the content script 155 in the Web page which has been loaded (step S403). The content script 155 performs the operation shown in FIG. 6, and also, waits for reception of an event that is in accordance with the change of the scroll position or the cursor position by a player.

In the case a render size is received from the relay server 23 (step S405), the browser extension application 140 of the information processing apparatus 100a changes the size of the window of the Web browser 130 in accordance with the horizontal width of the render size such that the render result of an existing Web page will be the same (step S406).

In the case a scroll position is received from the relay server 23 (step S407), the browser extension application 140 of the information processing apparatus 100a transmits the scroll position to the content script 155 which has been injected into the top level frame (step S408). When information on the scroll position is received from the browser extension application 140, the content script 155, which is in the state of waiting for reception of a scroll position (step S409), updates the scroll position on the existing Web page 150 (step S410). In the case a scroll position (left, top) is received from the browser extension application 140, the content script 155 may write a process as below in JavaScript, for example.

window.scrollTo(left, top);

In the case a cursor position is received from the relay server 23 (step S411), the browser extension application 140 of the information processing apparatus 100a transmits the cursor position to the content script 155, which has been injected into the top level frame (step S412). When the cursor position is received, the content script 155, which is in the state of waiting for reception of a cursor position (step S413), draws a cursor within the existing Web page (step S414). The cursor may be drawn by pasting an image, or may be drawn according to a specification designed to draw a figure on a browser, such as Canvas and the like. Additionally, at the time of drawing the cursor, the content script 155 adjusts the drawing position by z-index or the like in CSS (Cascading Style Sheets) so that the cursor is drawn above the existing Web page 150.

As described, by transmitting the details of an operation at the information processing apparatus 100a on the player side to the relay server 23, and the relay server 23 transferring the details of the operation to the player other than the transmission source and the audience member, display of one Web page can be shared in real time among the information processing apparatuses 100a and 100b on the player side and the information processing apparatuses 200a, 200b, and 200c on the audience side. Then, the details of the operation performed on the existing Web page 150 at the information processing apparatus on the player side are transmitted, via the relay server 23, to the information processing apparatuses on the player side and the audience side, other than the apparatus at which the operation was performed. The details of the operation performed on the existing Web page 150 at the information processing apparatus on the player side are thereby immediately reflected in other information processing apparatuses, and the details of the operation on the existing Web page 150 by a player can be displayed at the information processing apparatuses of other players and audience members.

In the foregoing, the operation of each device configuring the content sharing system 1 according to an embodiment of the present disclosure has been described. Next, user interfaces of Web browsers displayed on the information processing apparatus 100a on the player side and the information processing apparatus 200a on the audience side that configure the content sharing system 1 according to an embodiment of the present disclosure will be described.

### 1-4. Example User Interface

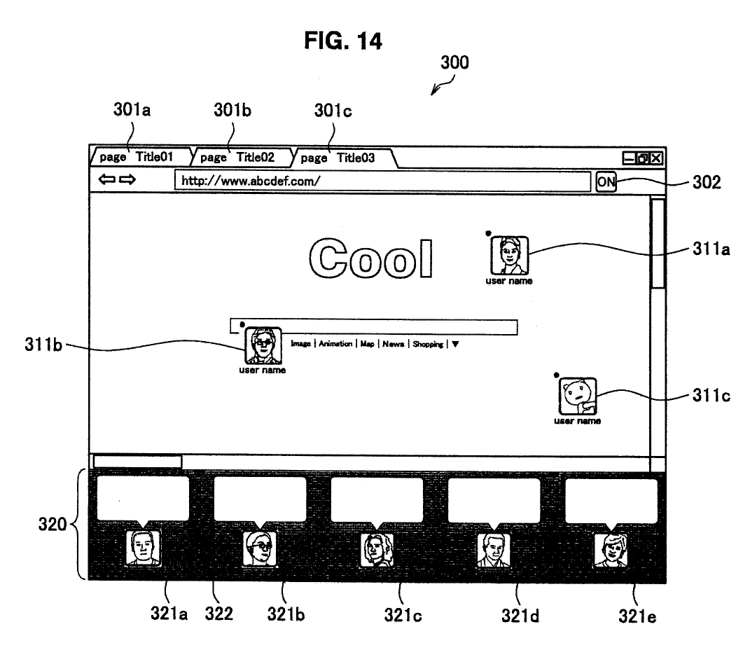

First, an example user interface of a Web browser that is displayed on the information processing apparatus on the player side will be described. FIG. 14 is an explanatory diagram showing a user interface 300 of the Web browser 130 displayed on the information processing apparatus on the player side. The user interface of the Web browser 130 that is displayed on the information processing apparatus on the player side (for example, the information processing apparatus 100a) is realized by the browser extension application 140.

The user interface 300 of the Web browser 130 is configured, including tabs 301a, 301b, and 301c, a sharing switch button 302, player icons 311a, 311b, and 311c, and an audience information display area 320. Audience icons 321a, 321b, 321c, 321d, and 321e, and feedback information 322 from the audience are displayed in the audience information display area 320. Additionally, in the present technology, the number of tabs is, of course, not limited to three.

The player icons 311a, 311b, and 311c are mouse cursors of respective players. Images for identifying the players and user names (shown as “user name” in FIG. 14) are displayed as the player icons 311a, 311b, and 311c. The players can move the player icons 311a, 311b, and 311c on the Web browser 130 by using the information processing apparatuses (for example, by operating with a mouse or touching the screen). Each player can share his/her operation in real time, via the relay server 23, with the information processing apparatuses of other players and the audience, by operating the Web browser 130 running on the information processing apparatus on the player side, as described above.

The sharing switch button 302 is a button for switching between on and off of sharing with other players and the audience. When a player operates the sharing switch button 302 and turns off the sharing, operations of the user on the window or the tabs will not be reflected in the information processing apparatuses of other players and the audience.

When there is a reaction from an audience member, through any of the information processing apparatuses 200a to 200c on the audience side, to an operation of a player, this reaction is displayed in the audience information display area 320. A reaction from an audience member may be text information input by the audience member that is displayed together with one of the audience icons 321a to 321e, or may be pressing of a button described below expressing clapping or laughter from the audience member.

By providing in this manner an area for displaying comments or feedback from the audience members separately from an area where the players perform operations on the Web page, each player can operate the Web page while viewing the comments or feedback from the audience members.

Various methods can be conceived as the display method of the audience icons 321a to 321e in the audience information display area 320. A display method of the audience icons 321a to 321e in the audience information display area 320 will be described later in detail.

FIG. 14 shows a case where the user interface 300 of the Web browser 130 displayed on the information processing apparatus 100a on the player side has the audience information display area 320 displayed in the lower part of the user interface 300, but the present disclosure is not limited to such an example. Also, it is needless to say that the display method of the audience icons 321a to 321e in the audience information display area 320, at the time of an audience member inputting text as feedback to the players, is not limited to a specific method, but the audience icons 321a to 321e may be displayed appearing from the lower part of the screen and moving upward or may be displayed fading in to the Web browser 130.

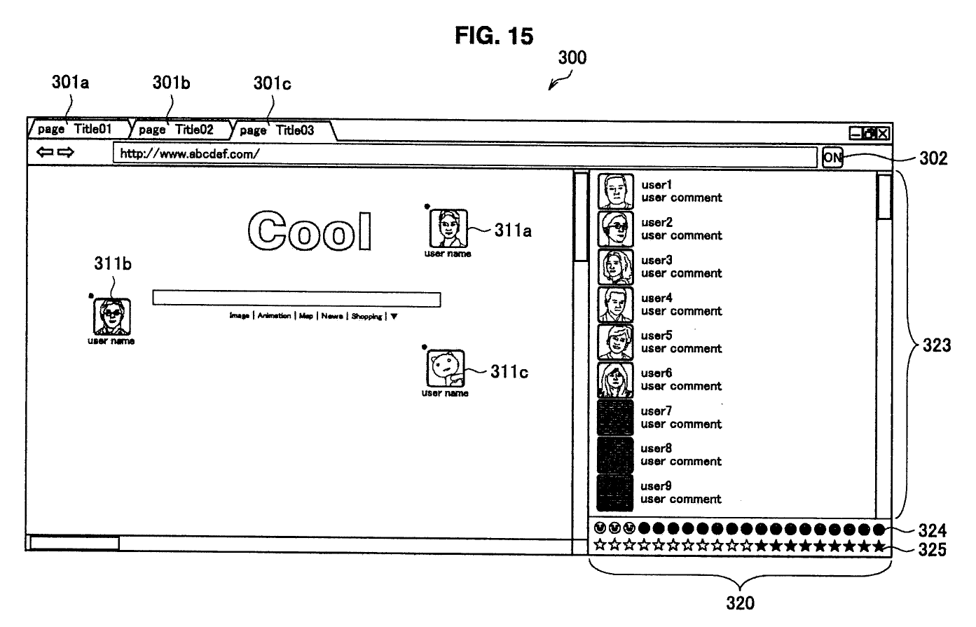

FIG. 15 is an explanatory diagram showing a user interface 300 of the Web browser 130 displayed on the information processing apparatus 100a on the player side.

The user interface 300 shown in FIG. 15 has the audience information display area 320 displayed on the right side of the user interface 300. Reactions from the audience are displayed in real time in the audience information display area 320 as in FIG. 14, but with the user interface 300 shown in FIG. 15, the reactions from the audience are displayed in the audience comment display area 323 in a chronological order. The name (shown as “user1” to “user9” in FIG. 15) of a user who has submitted a comment and the comment (shown as “user comment” in FIG. 15) are displayed in the audience comment display area 323. Furthermore, in addition to the audience comment display area 323, a laughter information display area 324 and a clapping information display area 325 are provided in the audience information display area 320 to display the number of times or frequency of pressing of a clap button 432 and a laugh button 433 described later.

As described, by displaying the comments from the audience in the audience information display area 320 in a chronological order, each player can check out the comment to talk about

In the foregoing, an example user interface of a Web browser displayed on the information processing apparatus on the player side has been described. Next, an example user interface of a Web browser displayed on the information processing apparatus on the audience side will be described.

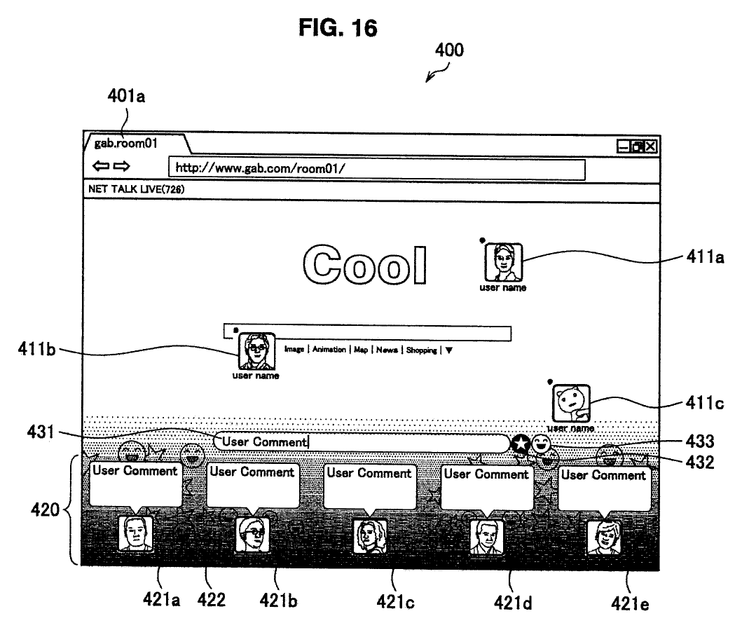

FIG. 16 is an explanatory diagram showing a user interface 400 of the Web browser 230 displayed on the information processing apparatus on the audience side. The user interface 400 of the Web browser 230 displayed on the information processing apparatus on the audience side (for example, the information processing apparatus 200a) is realized by the dedicated Web application 240.

The user interface 400 of the Web browser 230 displayed on the information processing apparatus on the audience side is configured, including a tab 401a, player icons 411a, 411b, and 411c, and an audience information display area 420. Audience icons 421a, 421b, 421c, 421d, and 421e, feedback information 422 from the audience, a text box 431, a clap button 432, and a laugh button 433 are displayed in the audience information display area 420.

The player icons 411a, 411b, and 411c are mouse cursors of respective players. As described above, when a player operates the Web browser 130 running on the information processing apparatus on the player side, the details of the operation is reflected in real time in the information processing apparatus on the audience side via the relay server 23. A player operation can thereby be shared with the audience in real time.

When there is a reaction from an audience member, through any of the information processing apparatuses 200a to 200c on the audience side, to an operation of a player, this reaction is displayed in the audience information display area 420. The name (shown as “user1” to “user5” in FIG. 16) of a user who has submitted a comment and the comment (shown as “User Comment” in FIG. 16) that are displayed together with the audience icons 421a to 421e are displayed as the reaction from the audience member. Information displayed in the audience information display area 420 may be text information input by an audience member in the text box 431, or may be pressing of the clap button 432 or the laugh button 433 described below expressing clapping or laughter of the audience member.

The text box 431, the clap button 432, and the laugh button 433 may be integrally displayed on the Web browser 230. The text box 431, the clap button 432, and the laugh button 433 are displayed only on the Web browser 230 that a corresponding audience member operates. The text box 431, the clap button 432, and the laugh button 433 are used by the audience member to return a reaction to a player operation, and if they are displayed at all times on the Web browser 230 even if the audience member is not returning a reaction to player operations, they will obstruct the viewing of the player operations. Thus, it is desirable that display of the text box 431, the clap button 432, and the laugh button 433 on the screen can be removed.

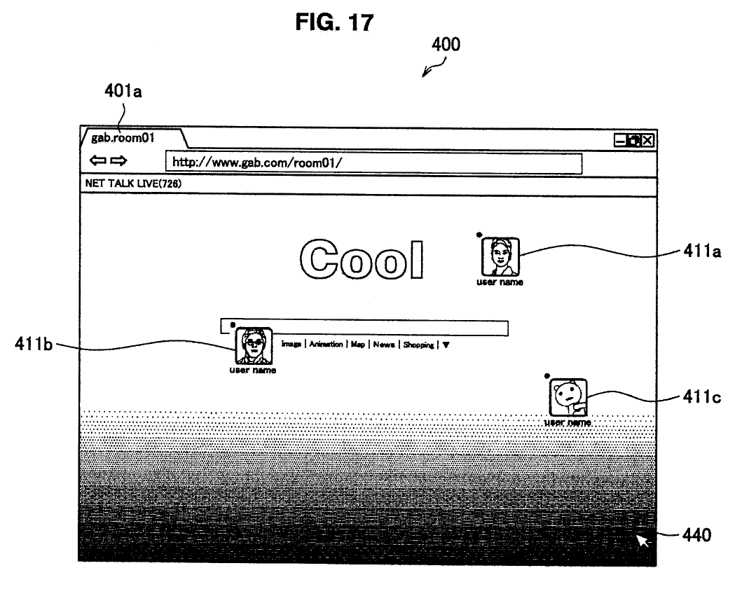

FIG. 17 is an explanatory diagram showing a user interface 400 of the Web browser 230 displayed on the information processing apparatus on the audience side, and shows a state where the text box 431, the clap button 432, and the laugh button 433 are removed from the screen. By removing the text box 431, the clap button 432, and the laugh button 433 from the screen when the audience member is not returning a reaction to player operations, viewing of the player operations can be prevented from being obstructed.

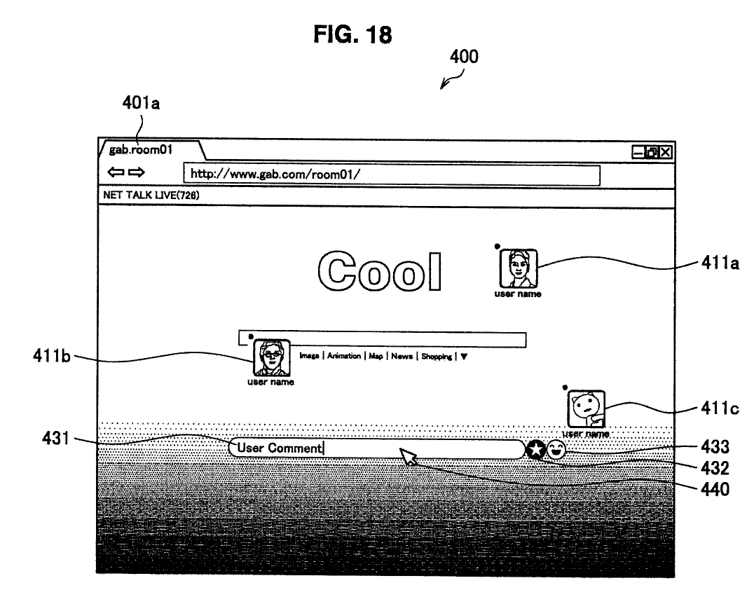

Then, when the audience member manipulates the mouse cursor 440 and moves the mouse cursor 440 to the area where the text box 431, the clap button 432, and the laugh button 433 are to be displayed, the text box 431, the clap button 432, and the laugh button 433 are displayed in the Web browser 230. FIG. 18 is an explanatory diagram showing a user interface 400 of the Web browser 230 displayed on the information processing apparatus on the audience side, and shows a state where the text box 431, the clap button 432, and the laugh button 433 are displayed in the Web browser 230 by the movement of the mouse cursor 440.

As shown in FIG. 18, in addition to when an audience member manipulates the mouse cursor 440, the text box 431, the clap button 432, and the laugh button 433 may also be displayed in the Web browser 230 when the audience member operates the keyboard at the time of returning a reaction to a player.

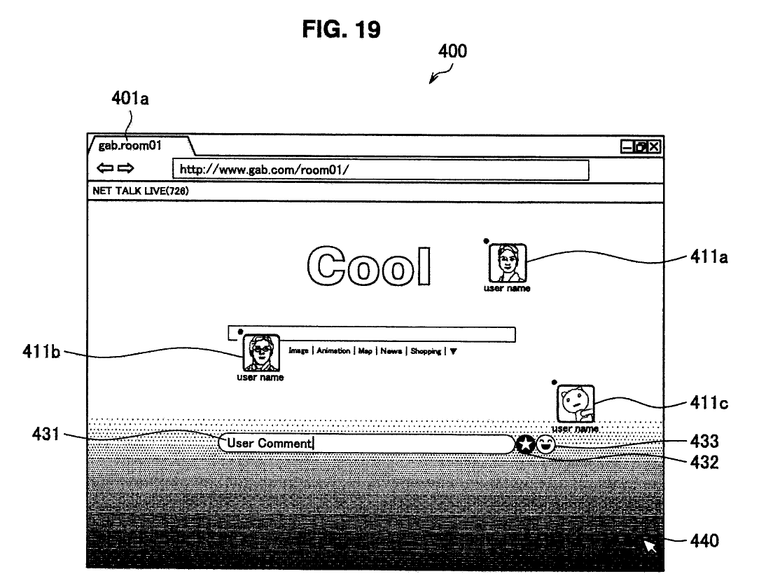

FIG. 19 is an explanatory diagram showing a user interface 400 of the Web browser 230 displayed on the information processing apparatus on the audience side, and shows a state where the text box 431, the clap button 432, and the laugh button 433 are displayed in the Web browser 230 by an operation of a keyboard by an audience member (for example, pressing of the space key or the Enter key). The user interface 400 shown in FIG. 19 is different from that of FIG. 18, and the mouse cursor 440 is not displayed in the area where the text box 431, the clap button 432, and the laugh button 433 are displayed, but the text box 431, the clap button 432, and the laugh button 433 are displayed in the Web browser 230.

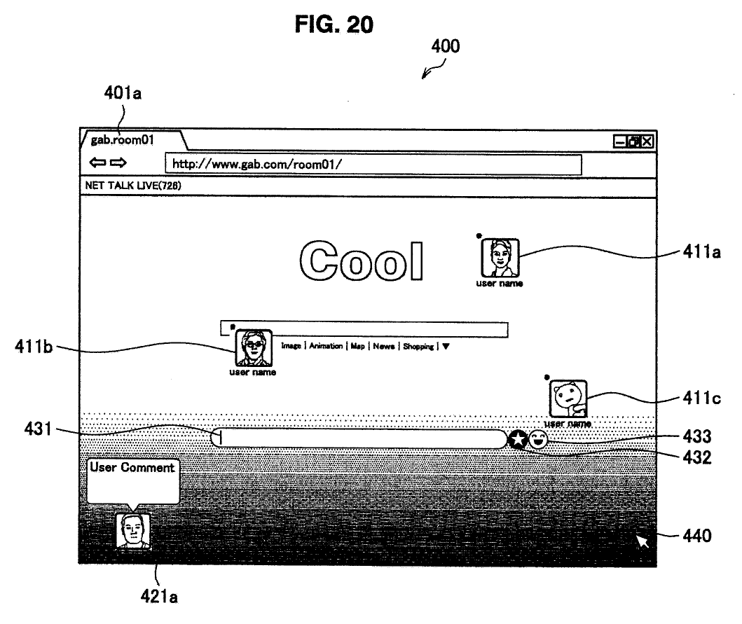

When an audience member inputs text into the text box 431 and enters the input to return a reaction to a player, the text is displayed in the audience information display area 420 together with the icon of this audience member. FIG. 20 is an explanatory diagram showing a user interface 400 of the Web browser 230 displayed on the information processing apparatus on the audience side, and shows a state where, based on text input from an audience member, the audience icon 421a is displayed in the audience information display area 420 together with the text input by the audience member.

This audience icon 421a that is displayed in the audience information display area 420 is displayed in the Web browsers of other players and audience members by the relay server 23. Accordingly, the reaction of an audience member to a player can be seen and perceived by not only the players, but also the audience members.

Also, it is needless to say that the display method of the audience icon 421a in the audience information display area 420 is not limited to a specific method, but the audience icon 421a may be displayed appearing from the lower part of the screen and moving upward or may be displayed fading in to the Web browser 230.

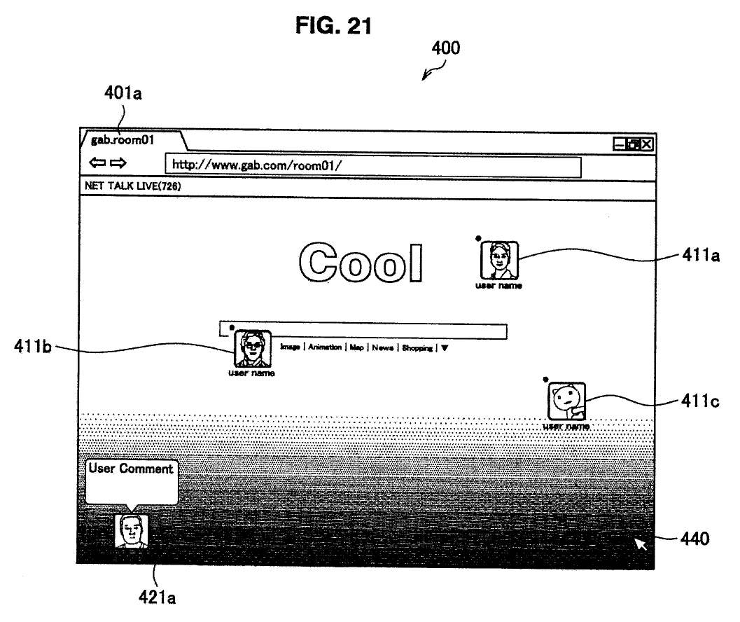

The text box 431, the clap button 432, and the laugh button 433 may be removed from the Web browser 230 when input of text by an audience member is complete. FIG. 21 is an explanatory diagram showing a user interface 400 of the Web browser 230 displayed on the information processing apparatus on the audience side, and shows a state where the text box 431, the clap button 432, and the laugh button 433 are removed from the Web browser 230 by the entering of text input by an audience member. By removing the text box 431, the clap button 432, and the laugh button 433 from the Web browser 230 by the entering of text input by an audience member as described above, viewing of an operation of the Web page by a player can be prevented from being obstructed.

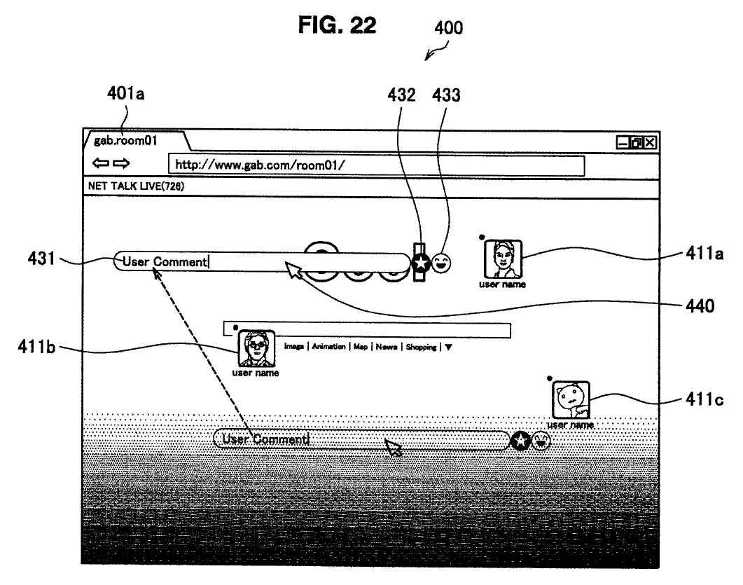

The display positions of the text box 431, the clap button 432, and the laugh button 433 can be made to move to arbitrary positions on the Web browser 230 by being dragged with a mouse, for example. FIG. 22 is an explanatory diagram showing a user interface 400 of the Web browser 230 displayed on the information processing apparatus on the audience side, and shows a state where the display positions of the text box 431, the clap button 432, and the laugh button 433 are moved by being dragged with a mouse. By moving the display positions of the text box 431, the clap button 432, and the laugh button 433 to arbitrary positions in this manner, viewing of an operation of the Web page by a player can be prevented from being obstructed.

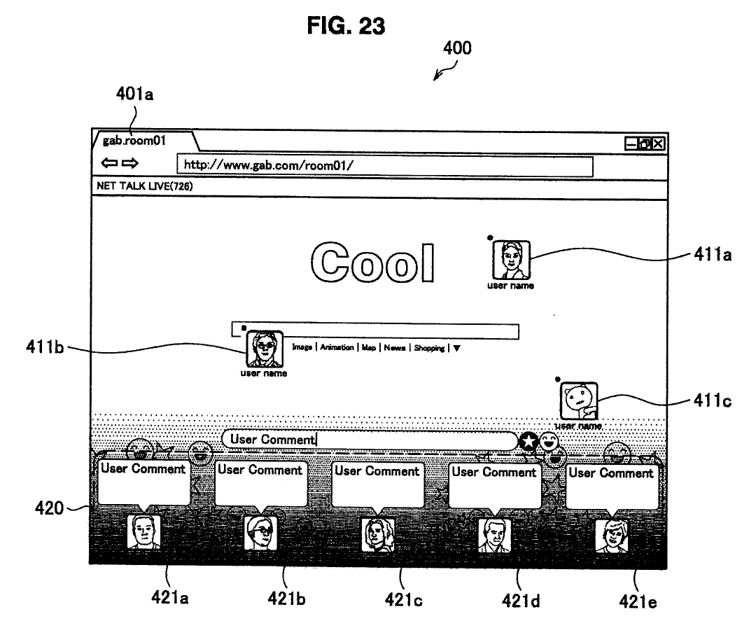

Next, an example of a display method of audience information in the audience information display area 420 will be described. FIG. 23 is an explanatory diagram showing a user interface 400 of the Web browser 230 displayed on the information processing apparatus on the audience side. The audience icons 421a to 421e are displayed in the audience information display area 420, and text input by an audience member can be shared between players and audience members via the relay server 23.

Display of audience information in this audience information display area 420 may be performed according to certain rules. In the following, display of audience information in the audience information display area 420 will be described, taking one rule as an example.

For example, the audience information display area 420 on the user interface 400 of the Web browser 230 is allowed to have nine audience icons displayed. The display positions are numbered one to nine from the left. Then, audience icons are displayed from the left at the odd-numbered display positions, and when an audience icon is displayed at the ninth position, audience icons are then displayed from the left at the even-numbered display positions. Then, when an audience icon is displayed at the eighth position, audience icons are again displayed from the left at the odd-numbered display positions. By displaying the audience icons in this manner, the visibility of the audience icons can be enhanced, and by causing the comments from the audience members to appear regularly, a larger number of user comments can be simultaneously displayed while securing readable time for the players and the audience members. Also, even if the window sizes differ depending on the respective display environment, the appearance timing or relative position of a comment from an audience member does not have to be changed.

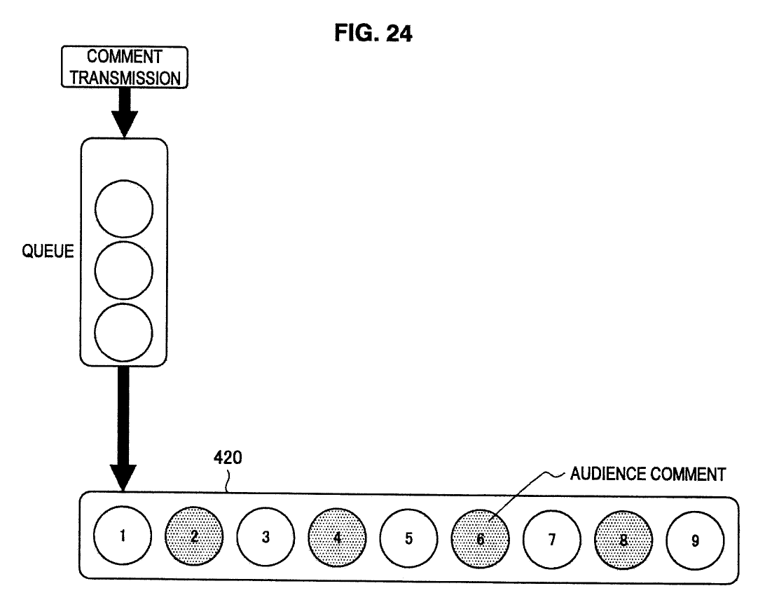

FIG. 24 is an explanatory diagram showing an overview of display of comments sent from the audience. Comments from the audience are stored in a queue in the relay server 23, and are displayed, in the order of input by the audience members, in the audience information display area 420 according to the above-described rule. That is, the first audience icon is displayed at the first position in the audience information display area 420 of FIG. 24, and then, the audience icons are displayed in the order of the third, fifth, seventh, and ninth positions. When an audience icon is displayed at the ninth position, the audience icons are then displayed in the order of second, fourth, sixth, and eighth positions. When an audience icon is displayed at the eighth position, an audience icon is again displayed at the first position.

Although a detailed explanation will be given later, when an audience icon is once displayed, the display may gradually fade out. For example, when explaining using FIG. 24, after an audience icon is displayed at the first position, its display may fade out with time, and the audience icon displayed at the first position may be completely removed from the screen before an audience icon is displayed in the second position. Then, audience icons will not be displayed with the same strength, and the readability of comments of the audience can be enhanced.

Additionally, FIG. 24 shows only the display in the audience information display area 420, but it is needless to say that the same method is applied to the audience information display area 320 that is displayed in the Web browser 130 on the player side.

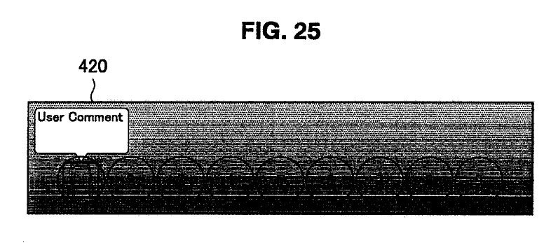

FIG. 25 is an explanatory diagram showing an overview of display of comments sent from the audience, and shows a state where the first audience icon is displayed at the first position in the audience information display area 420 of FIG. 24.

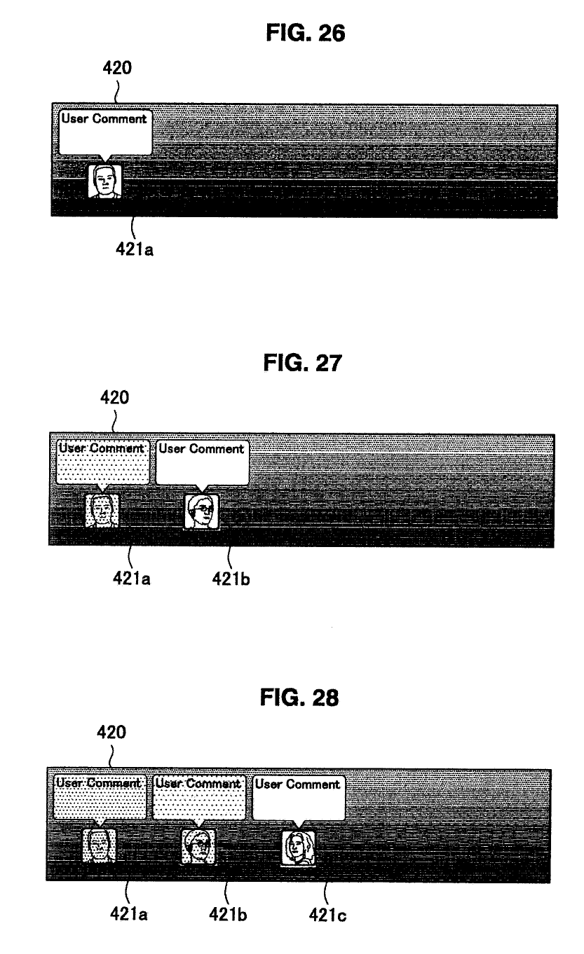

FIGS. 26 to 34 are explanatory diagrams extracting and showing the audience information display area 420 of the user interface 400 of the Web browser 230 that is displayed on the information processing apparatus on the audience side. FIG. 26 shows a state where an audience icon 421a is displayed at the first position in the audience information display area 420 of FIG. 24.

When the audience icon 421a is displayed at the first position in the audience information display area 420 of FIG. 24, an audience icon 421b is then displayed at the third position in the audience information display area 420. FIG. 27 shows a state where the audience icon 421b is displayed at the third position in the audience information display area 420 of FIG. 24. At this time, the audience icon 421a that is displayed earlier is displayed in such a way that its density is gradually reduced.

Next, an audience icon 421c is displayed at the fifth position in the audience information display area 420. FIG. 28 shows a state where the audience icon 421c is displayed at the fifth position in the audience information display area 420 of FIG. 24. Also, the audience icons 421a and 421b that are displayed earlier are displayed in such a way that their density is gradually reduced.

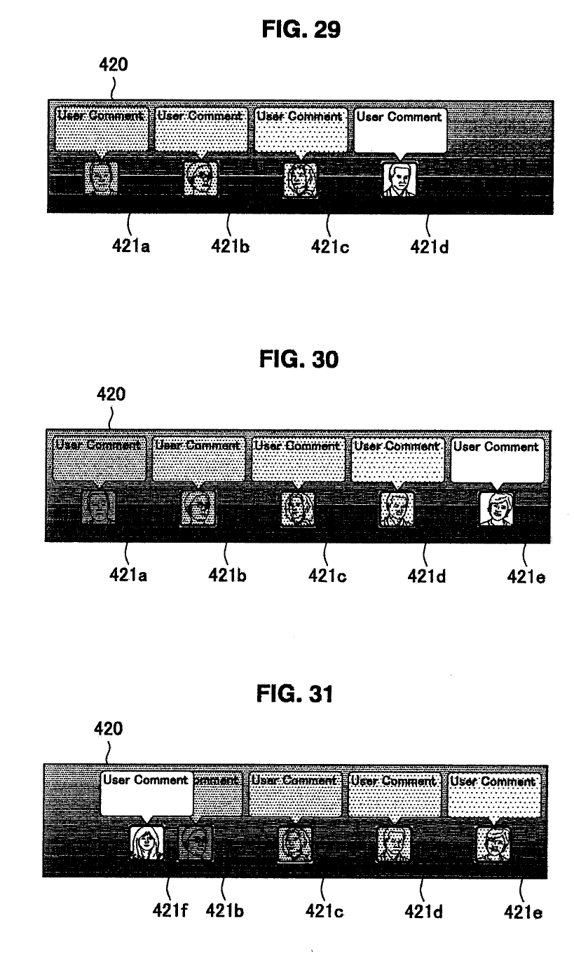

Next, an audience icon 421d is displayed at the seventh position in the audience information display area 420. FIG. 29 shows a state where the audience icon 421d is displayed at the seventh position in the audience information display area 420 of FIG. 24. Also, the audience icons 421a, 421b, and 421c that are displayed earlier are displayed in such a way that their density is gradually reduced.

Then, an audience icon 421e is displayed at the ninth position in the audience information display area 420. FIG. 30 shows a state where the audience icon 421e is displayed at the ninth position in the audience information display area 420 of FIG. 24. Also, the audience icons 421a, 421b, 421c, and 421d that are displayed earlier are displayed in such a way that their density is gradually reduced.

By the time the audience icon 421e is displayed at the ninth position in the audience information display area 420, the density of the audience icon 421a that was displayed first is considerably reduced. Then, when an audience icon is displayed at the second position in the audience information display area 420, the audience icon 421a that was displayed first is completely removed from the screen.

Next, an audience icon 421f is displayed at the second position in the audience information display area 420. FIG. 31 shows a state where the audience icon 421f is displayed at the second position in the audience information display area 420 of FIG. 24. Also, the audience icons 421b, 421c, 421d, and 421e that are displayed earlier are displayed in such a way that their density is gradually reduced. Also, the audience icon 421a that was displayed first is completely removed from the screen.

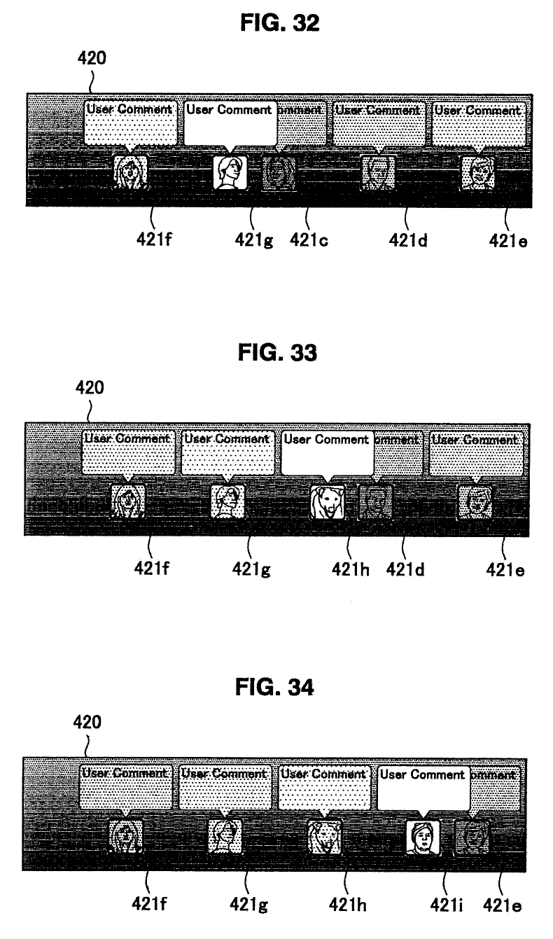

Next, an audience icon 421g is displayed at the fourth position in the audience information display area 420. FIG. 32 shows a state where the audience icon 421g is displayed at the fourth position in the audience information display area 420 of FIG. 24. Also, the audience icons 421c, 421d, 421e, and 421f that are displayed earlier are displayed in such a way that their density is gradually reduced. Also, the audience icon 421b is completely removed from the screen.

Then, an audience icon 421h is displayed at the sixth position in the audience information display area 420. FIG. 33 shows a state where the audience icon 421h is displayed at the sixth position in the audience information display area 420 of FIG. 24. Also, the audience icons 421d, 421e, 421f, and 421g that are displayed earlier are displayed in such a way that their density is gradually reduced. Also, the audience icon 421c is completely removed from the screen.

Then, an audience icon 421i is displayed at the eighth position in the audience information display area 420. FIG. 34 shows a state where the audience icon 421i is displayed at the eighth position in the audience information display area 420 of FIG. 24. Also, the audience icons 421e, 421f, 421g, and 421h that are displayed earlier are displayed in such a way that their density is gradually reduced. Also, the audience icon 421d is completely removed from the screen.

When the audience icon 421i is displayed at the eighth position in the audience information display area 420 of FIG. 24, an audience icon is again displayed at the first position in the audience information display area 420 of FIG. 24 at which the audience icon 421a was displayed first. By displaying the audience icons in a cyclic manner as described above, a larger number of audience comments can be simultaneously displayed while securing, for the players and the audience members, readable time for the comments from the audience.

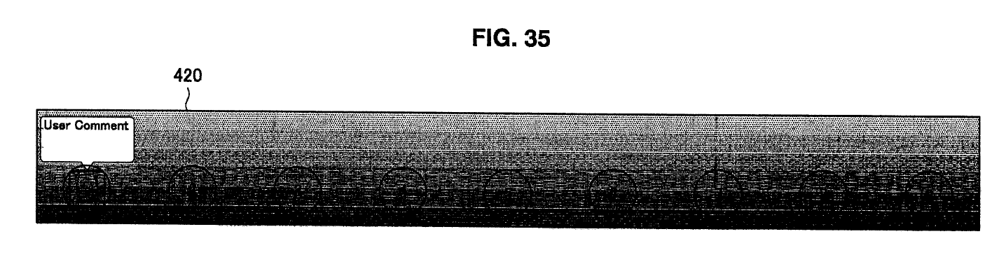

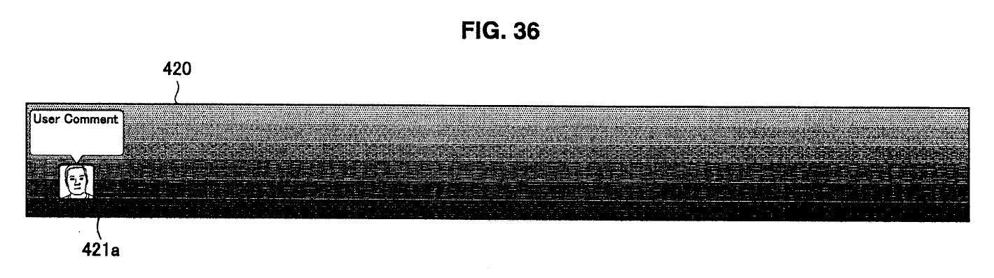

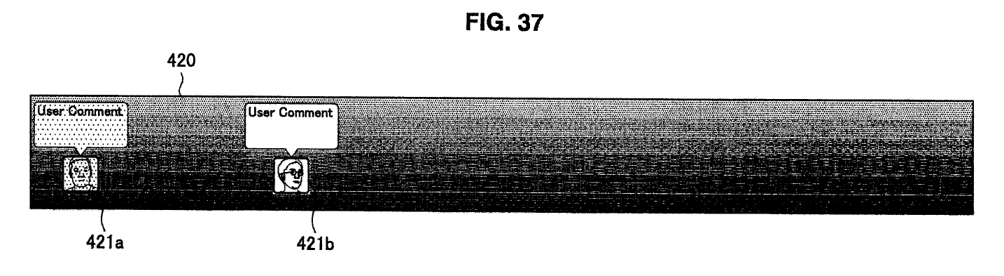

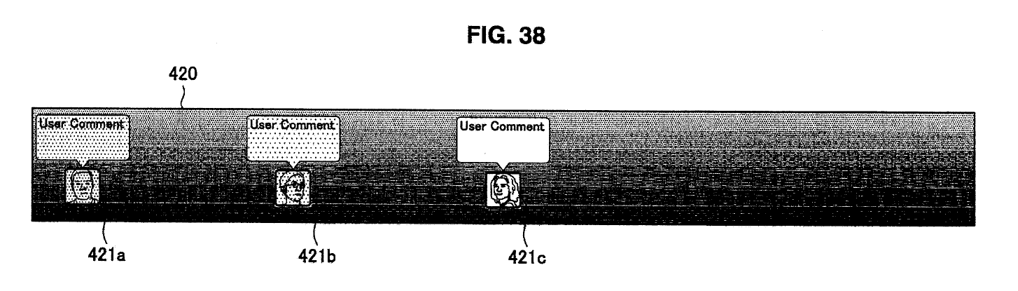

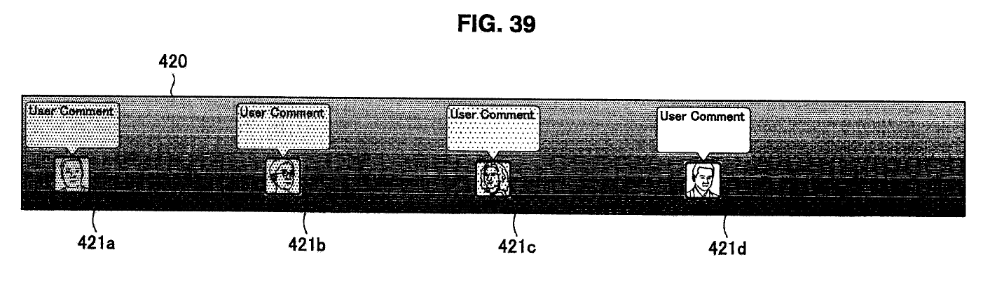

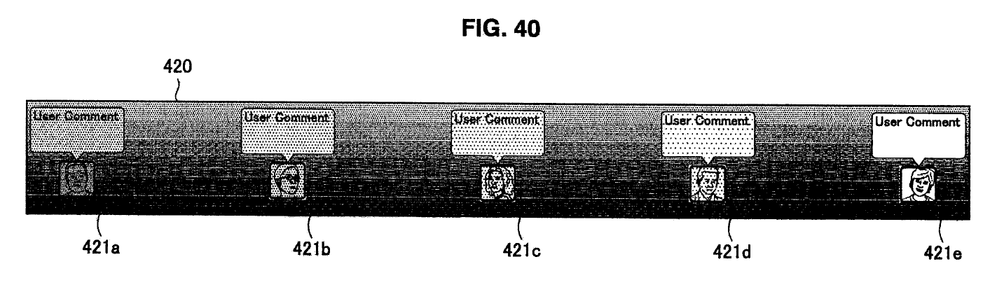

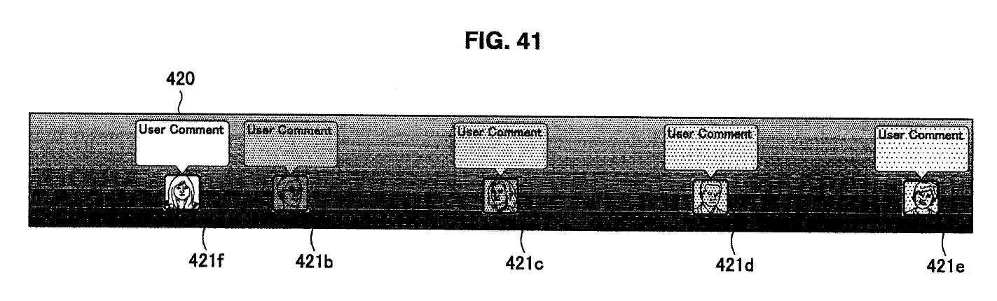

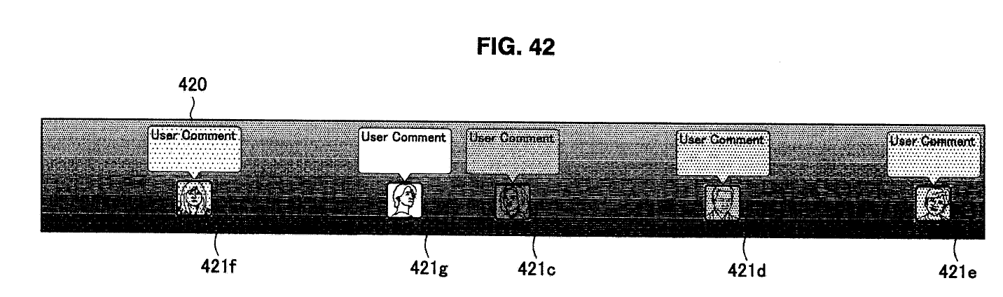

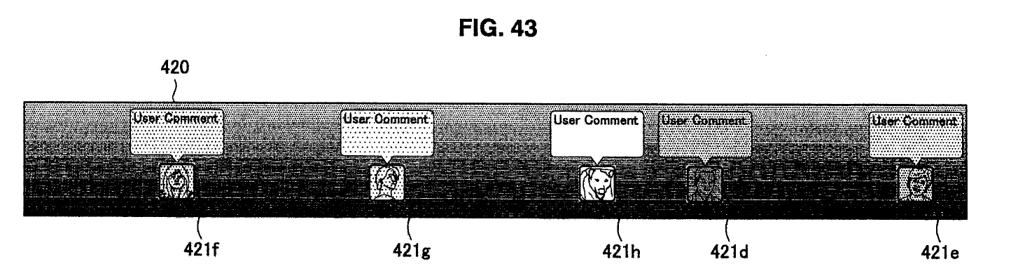

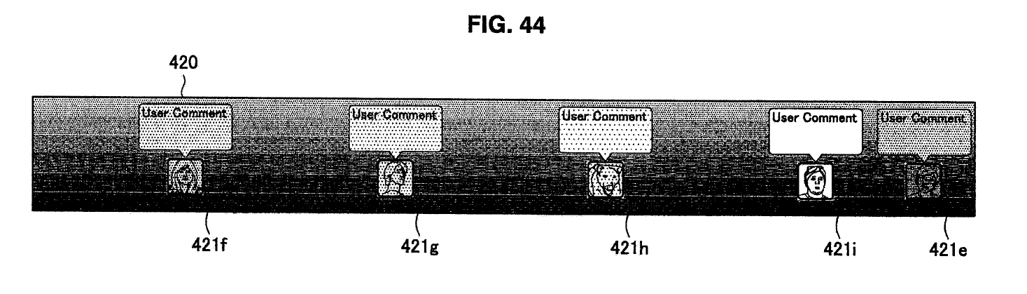

Even if the window size of a Web browser changes, the pattern of display of the audience icons is not changed. FIG. 35 is an explanatory diagram showing an overview of display of comments sent from the audience, and schematically shows a state where the first audience icon is displayed at the first position in the audience information display area 420 of FIG. 24. Also, in FIG. 35, the Web browser 230 is horizontally wider compared to FIG. 25. The same can be said about FIGS. 36 to 44 below.

FIGS. 36 to 44 are explanatory diagrams extracting and showing the audience information display area 420 of the user interface 400 of the Web browser 230 that is displayed on the information processing apparatus on the audience side. FIG. 36 shows a state where an audience icon 421a is displayed at the first position in the audience information display area 420 of FIG. 24.

In the following, audience icons 421a to 421i are sequentially displayed in the audience information display area 420 in the order of first position->third position->fifth position->seventh position->ninth position->second position->fourth position->sixth position->eighth position, similarly to the display of the audience icons 421a to 421i in the audience information display area 420 shown in FIGS. 26 to 34. By displaying the audience icons in a cyclic manner as described above, a larger number of audience comments can be simultaneously displayed while securing, for the players and the audience members, readable time for the comments from the audience. Also, even if the window sizes differ depending on the respective display environment, an audience comment can be shared between the players and the audience members without changing the appearance timing or relative position of the audience comment.

In the foregoing, an example of a display method of audience information in the audience information display area 420 has been described. It is needless to say that the display method of audience information in the audience information display area 420 is not limited to the example described above. For example, in the explanation above, audience icons were displayed regularly from the left, but the audience icons may also be displayed regularly from the right.

Various other methods can be used to display audience information in the audience information display area 420. For example, comments from the same audience member may be displayed at the same position at all times. Or, for example, audience information of an audience member who submits many comments may be preferentially displayed at a fixed position in the audience information display area 420.

Next, an example of a process for avoiding congestion due to messages flooding in from the audience will be described. When the number of audience members increase, it is conceivable that comments will be submitted at a time from many audience members. If all of the comments from the audience members are displayed, the timeliness of a comment from an audience member may be lost, and by the time the comment is displayed, players may have moved to a new topic. Thus, as a process for avoiding congestion, the relay server 23 provides, at a stage prior to display of comments from audience members, a queue for sending out messages within a certain period of time, and counts the number of comments waiting in the queue. Then, when the counted number of comments waiting exceeds a specified threshold, the relay server 23 may prohibit transmission of comments from audience members, and stop receiving comments from the audience members.

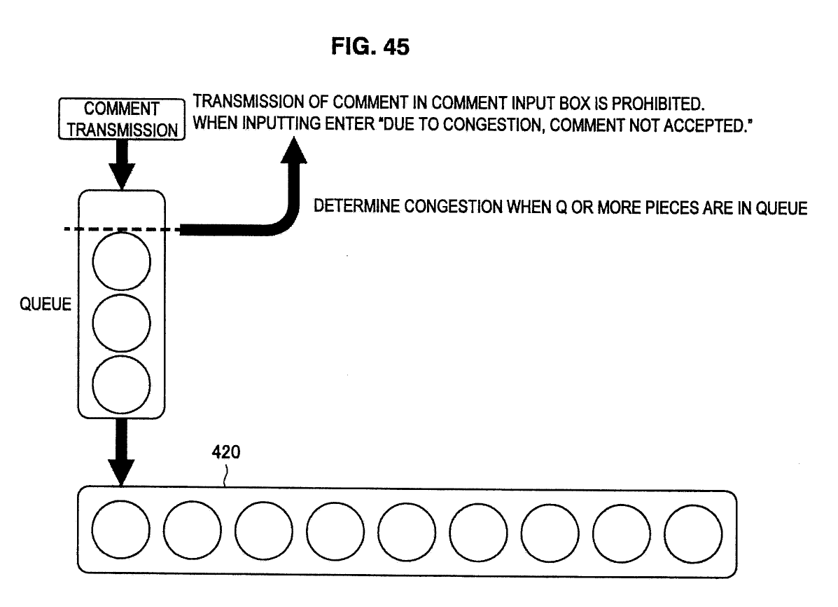

FIG. 45 is an explanatory diagram showing an overview of display processing of comments from audience members. In FIG. 45, comments sent from audience members are temporarily stored in a queue in the relay server 23, and displayed, in the order of transmission, in the audience information display area 420 by the display method described above. However, when the number of comments waiting reaches a predetermined threshold q, the relay server 23 stops receiving input of comments. As a method of stopping reception of input of comments, for example, when a comment is input in the text box 431 by an audience member and the comment is entered, a message to the effect of congestion (for example, “Due to congestion, comment not accepted.”) is displayed in the text box 431 that is displayed in the Web browser that the audience member who has input the comment is operating.

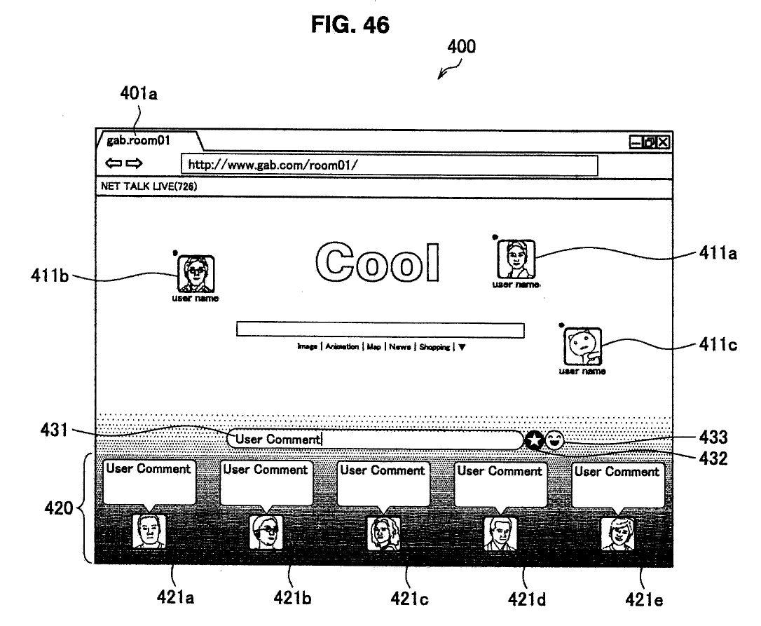

FIG. 46 is an explanatory diagram showing a user interface 400 of the Web browser 230 displayed on the information processing apparatus on the audience side, and shows a state where an audience member inputs a comment in the text box 431 and tries to enter the input comment in a situation where the number of comments waiting stored in the queue of the relay server 23 has reached the predetermined threshold q.

If an audience member inputs a comment in the text box 431 and enters the input comment in this state, since the number of comments waiting stored in the queue in the relay server 23 is at the predetermined threshold q, the relay server 23 prohibits reception of the comment, and causes a message to the effect of congestion in the text box 431 that is displayed in the Web browser that is being operated by the audience member who has input the comment.

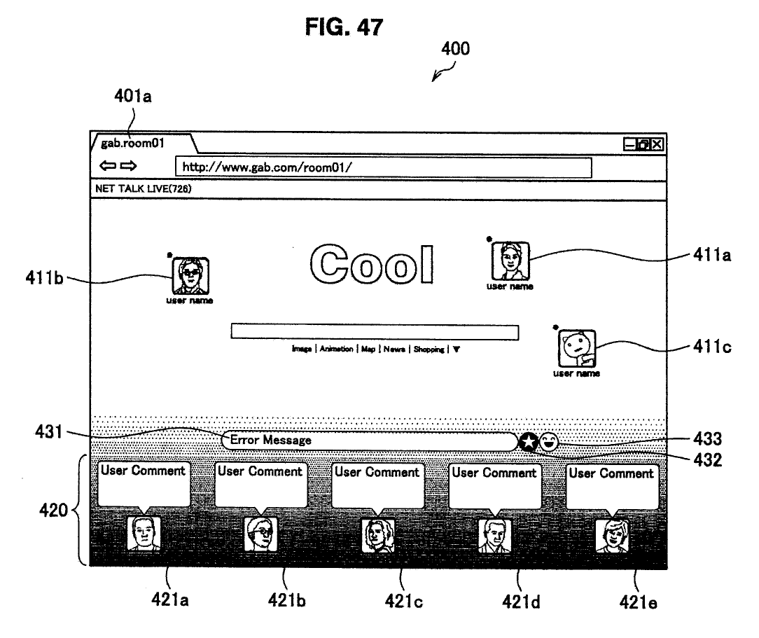

FIG. 47 is an explanatory diagram showing a user interface 400 of the Web browser 230 displayed on the information processing apparatus on the audience side, and shows a state where a shift has occurred from a state shown in FIG. 46 to a state where an audience member entered a comment input in the text box 431. In FIG. 47, a message to the effect of congestion is displayed in the text box 431. Then, when a predetermined time elapses from display of the error message in the text box 431, the error message is erased from the text box 431, and the state returns to an input wait state. The audience member can thereby perceive that many comments are flooding in, and can input the comment again after the predetermined time has elapsed.

Elements of feelings such as clapping and laughter for a remark or an operation on a Web page by a player may be conveyed to participants by pressing down the clap button 432 or the laugh button 433 displayed in the Web browser 230 on the audience side. Also, by expressing the amount of pressing by all the audience members of the clap button 432 and the laugh button 433 within a predetermined time using a feedback display or sound effects, participants can feel the excitement at the event space.

A feedback amount F of the entire audience is calculated based on the pressing of the clap button 432 and the laugh button 433 by the audience members. The feedback amount F is calculated by dividing the number of actions of the entire audience by a predetermined time T. That is, feedback about F is equal to the number of actions/T.

Then, the amount of effects to be displayed in the audience information display area 320 or 420 is changed according to the feedback F calculated in the above manner. For example, when using visual effects as the effects, the frequency of particle appearance is changed as the amount of visual effects, and when using sound effects, the type of SE (sound effect) that is in accordance with amount is changed as the amount of sound effects.

When the number of players increases, it may become difficult to perceive which player is making a remark. Thus, it is desirable to provide a mechanism that enables to easily identify which player is making a remark or which player is manipulating the mouse.

For example, regarding identification as to which player is speaking, the expression of a player icon may be changed based on the volume from the microphones of players to thereby enable identification as to which player is speaking. Also, regarding identification as to which player is performing an operation, the expression of a player icon may be changed with a mouse manipulation (movement, click, drag, or the like) of a player as a trigger to thereby enable identification as to which player is performing an operation.

A Web site presented by a player that is displayed on the Web browser 230 on the audience side may be displayed in a different window or under a different tab by an operation of an audience member. For example, a Web page that is displayed may be displayed in a different window or under a different tab by clicking on an area, on the Web browser 230 on the audience side, other than the area displaying the text box 431, the clap button 432, and the laugh button 433.

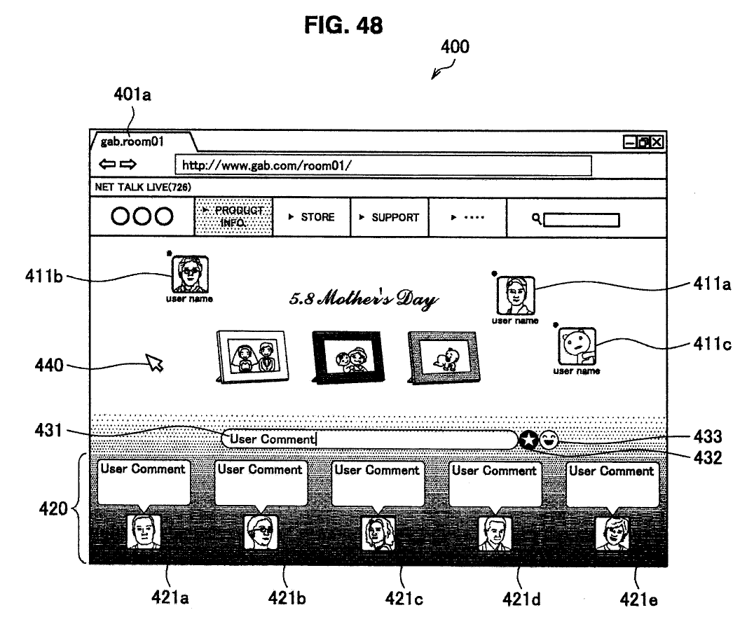

FIG. 48 is an explanatory diagram showing a user interface 400 of the Web browser 230 displayed on the information processing apparatus on the audience side, and shows a state where a Web page presented by a player is about to be displayed under a different tab by a manipulation of the mouse cursor 440 by an audience member. When an audience member moves the mouse cursor 440, for example, to an area where the text box 431, the clap button 432, and the laugh button 433 are not displayed and clicks the mouse, a Web page that is displayed under a tab 401a is displayed under another tab.

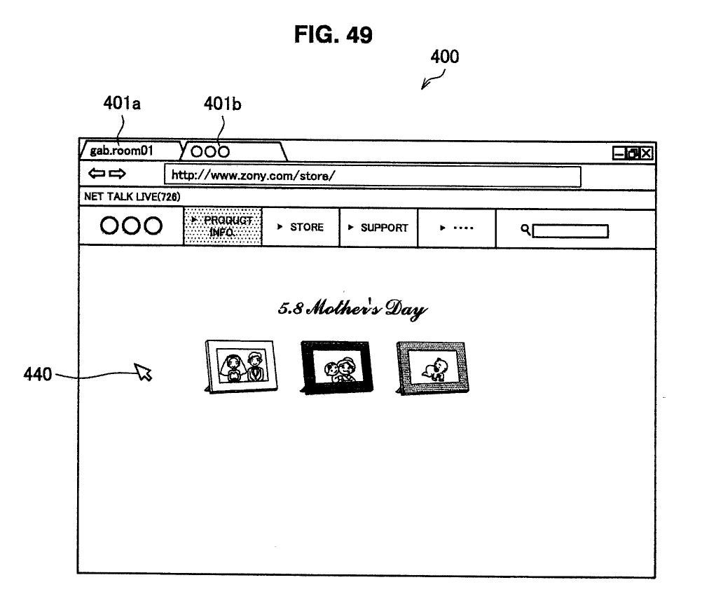

FIG. 49 is an explanatory diagram showing a user interface 400 of the Web browser 230 displayed on the information processing apparatus on the audience side, and shows a state where a shift has occurred from the state shown in FIG. 48 to a state where a Web site presented by a player is displayed under a tab 401b different from the tab 401a by a manipulation of the mouse cursor 440 by an audience member. By displaying a Web page presented by a player in a different window or under a different tab by a manipulation of the mouse cursor 440 by an audience member, the audience member is enabled to check at a later time the contents of the Web page presented by the player.

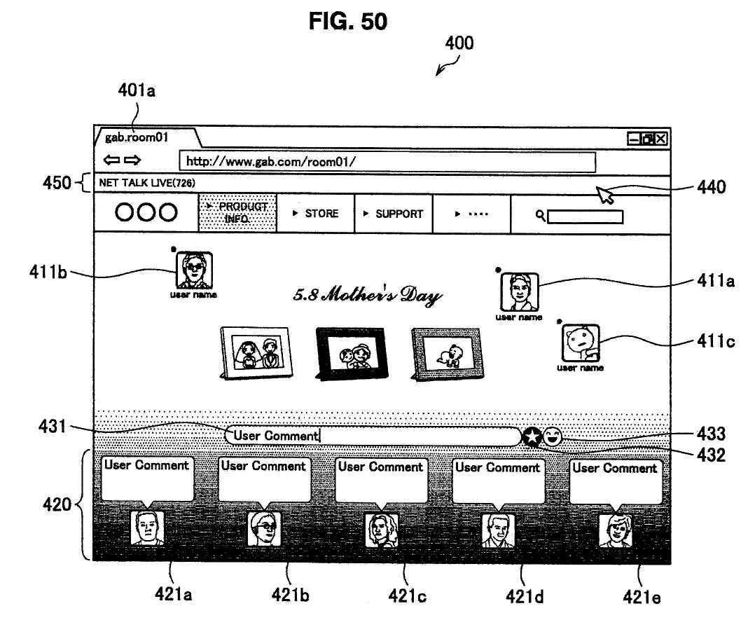

FIG. 50 is an explanatory diagram showing a user interface 400 of the Web browser 230 displayed on the information processing apparatus on the audience side, and shows a state where display under a different tab is about to be performed by a manipulation of the mouse cursor 440 by an audience member on a banner displayed in the Web site presented by a player. With an audience member clicking on the banner displayed in a banner display area 450 in the Web site presented by a player, the Web page at the link destination of the banner is displayed under a different tab.

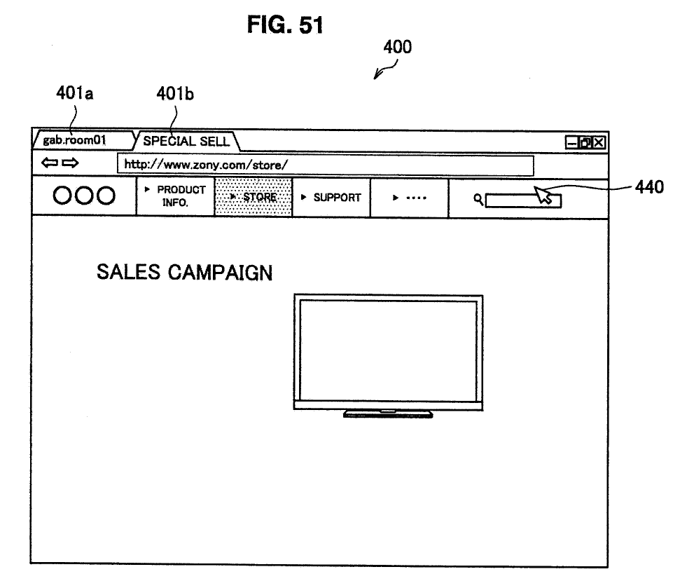

FIG. 51 is an explanatory diagram showing a user interface 400 of the Web browser 230 displayed on the information processing apparatus on the audience side, and shows a state where a shift has occurred from the state shown in FIG. 50 to a state where a Web page at the link destination of a banner of a Web page presented by a player is displayed under a tab 401b different from a tab 401a by a manipulation of the mouse cursor 440 by an audience member on the banner. By displaying, in this manner, a Web page at the link destination of a banner of a Web page presented by a player in a different window or under a different tab, an audience member is enabled to check at a later time the contents of the Web page.

Various events using the Internet can be realized by using the content sharing system 1 according to an embodiment of the present disclosure as described above. In the following, an example of holding a seminar, as an example of the event, on a new product using the Internet will be described.

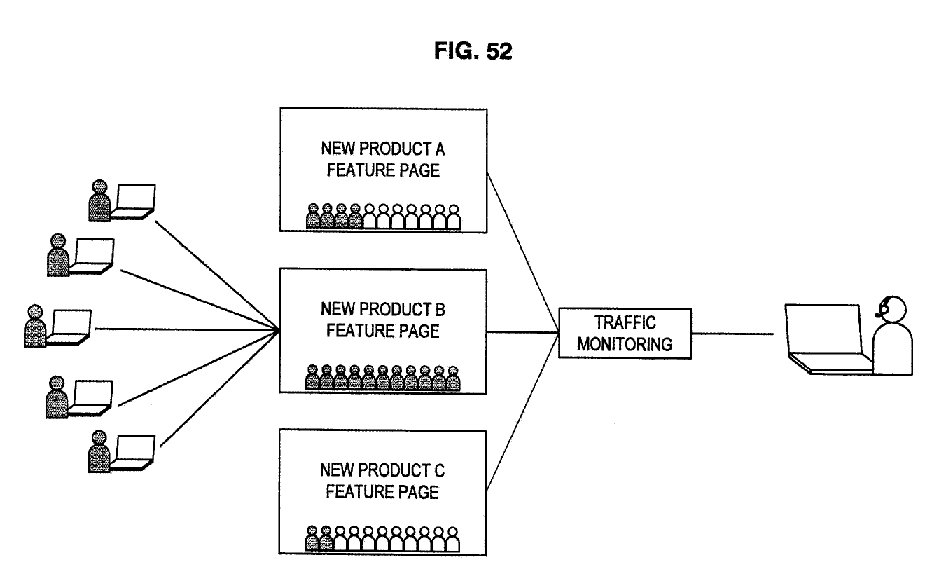

FIG. 52 is an explanatory diagram showing an example of an online event that uses the content sharing system 1 according to an embodiment of the present disclosure, and shows an overview of a seminar event of new products. For example, a plurality of Web pages featuring new products are set up, and the person who has set up the Web pages monitors the visitors to each Web page or the duration of stay at the Web page, and when the number of visitors to a certain Web page or the duration of stay at the Web page reaches a predetermined value, the person who has set up the Web pages or an administrator notifies each Web page to start the seminar event of a new product. FIG. 52 shows a case where Web pages each featuring a new product A, B, or C are set up, and there are five visitors to the Web page featuring the new product B. Additionally, it is needless to say that the method of monitoring the visitors to a Web page or the duration of stay at the Web page is not limited to a specific method.

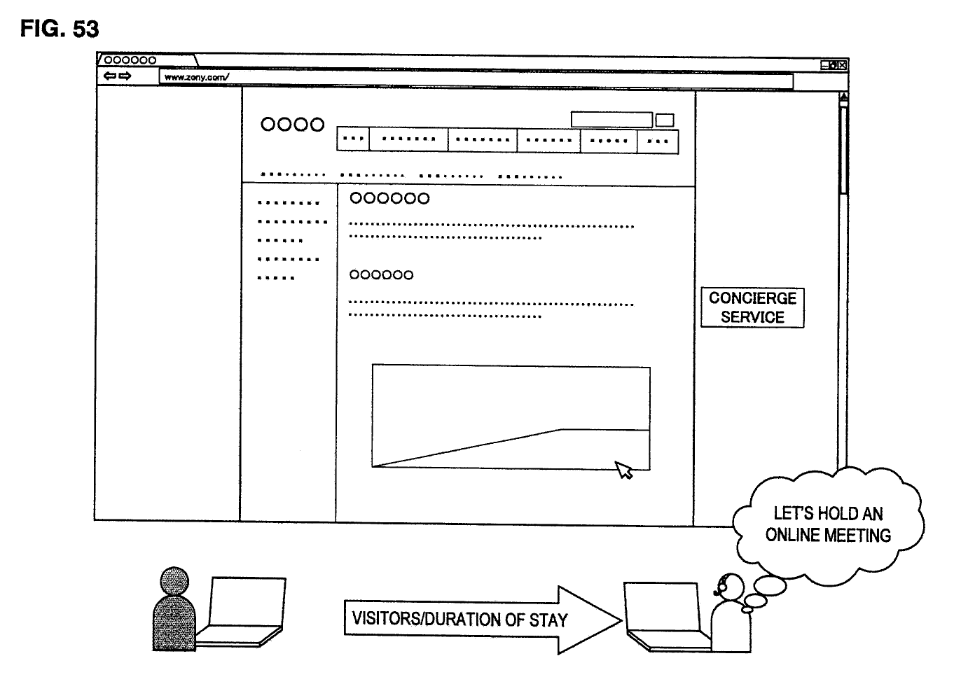

FIG. 53 is an explanatory diagram showing an example of an online event that uses the content sharing system 1 according to an embodiment of the present disclosure, and shows a state where a person who has set up a Web page or an administrator is monitoring the visitors to the Web page or the duration of stay at the Web page. When the number of visitors to the Web page or the duration of stay at the Web page reaches a predetermined value, the person who has set up the Web page or the administrator notifies each Web page to start the seminar event of a product.

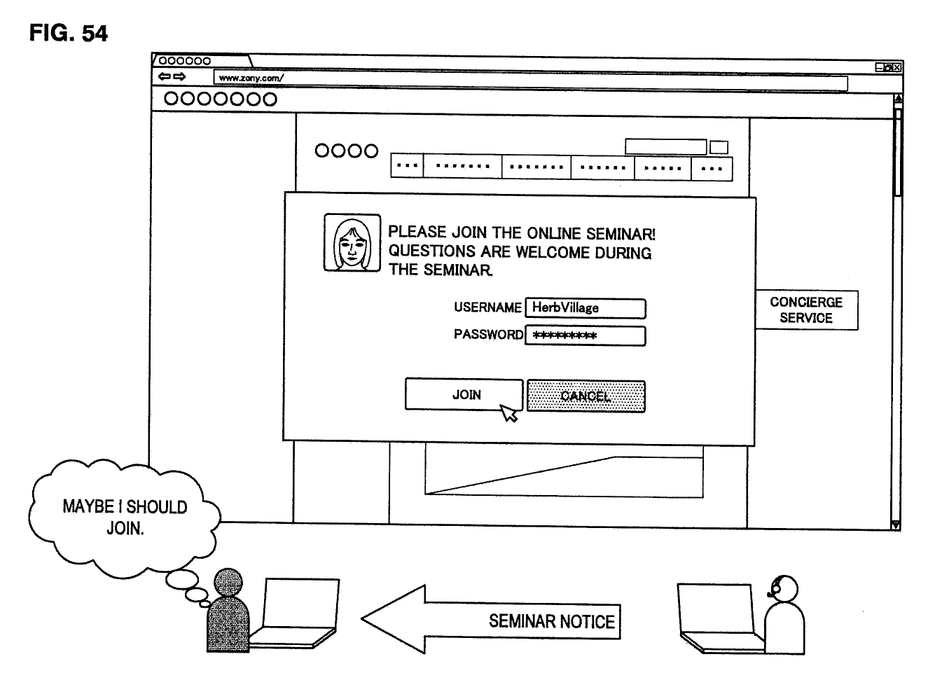

FIG. 54 is an explanatory diagram showing an example of an online event that uses the content sharing system 1 according to an embodiment of the present disclosure, and shows a state where a person who has set up a Web page or an administrator is notifying a Web browser of a visitor to the Web page of start of a seminar event. Then, if the visitor to the Web page joins the seminar event, the person who has set up the Web page or the administrator will be a player and the visitor to the Web page will be an audience member, and the audience member is enabled to view the description of a new product given using the Web browser of the player.

Additionally, the entrance to the seminar event may be linked to another Web page or another online service. Even if a Web page that is shared changes, it is possible to fix the URL of the online event that uses the Internet.

Various events using a Web page can be provided by using the content sharing system 1 according to an embodiment of the present disclosure. For example, the content sharing system 1 according to an embodiment of the present disclosure can be used for, besides seminar events on products as described above, introduction by a plurality of players of Web pages to be paid attention to, promotion events for musicians, and the like.

Additionally, in the above explanation, an example has been given taking a Web page on the Internet as the content to be shared, but the content to be shared is not limited to such an example. That is, the content to be shared may be video content, image content, document data, or the like, and the content may be shared between a player and the audience and be displayed, by displaying these pieces of content on the Web browser.

Also, in the above explanation, the clap button 432 and the laugh button 433 are displayed on the Web browser 230 for the audience to return emotional reactions such as laughter and clapping, but the present technology is not limited to such an example. For example, if the information processing apparatus that an audience member operates is a mobile terminal and an accelerometer, a tilt sensor or the like is provided in this terminal, emotional reactions such as laughter and clapping may be returned from the audience member by the information processing apparatus being tilted or moved.

### 2. Summary

As described above, with the content sharing system 1 according to an embodiment of the present disclosure, communication such as a chat performed among a plurality of people while viewing a popular Web page can be realized using only a Web browser. The audience side does not have to install special applications and can participate in the communication just by opening a specific Web page by the Web browser, and display contents can be correctly shared with other audience members and players without restricting audience members to specific appliances and even if the window sizes of the Web browsers differ from each other.

Also, with the content sharing system 1 according to an embodiment of the present disclosure, by displaying comments from the audience in a cyclic manner as described above, communication can be performed without reducing the visibility of shared content, such as a document or a video, or the timeliness of a topic, and also a larger number of comments can be simultaneously displayed, and further, even if the window sizes differ depending on the respective display environment, the appearance timing or relative position of a comment from an audience member does not change, and thus smooth communication can be achieved. Furthermore, for the audience to return emotional reactions such as clapping and laughter, user interfaces for returning these emotional reactions are provided, and thus swift communication from the audience is enabled without increasing the number of messages sent from the audience.

Additionally, series of control processes by each device described in the present specification may be realized using any of software, hardware, and a combination thereof. Programs constituting the software are stored in advance in a computer-readable recording medium that is provided within or outside each device, for example. Then, each program is read by a RAM (Random Access Memory) at the time of execution and executed by a processor such as a CPU (Central Processing Unit), for example.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1)

An information processing apparatus including:

a script management unit for injecting a script for monitoring an operation, by a user who directly operates content, on content of the user into the content, and communicating with the script injected into the content; and

a user operation information transmission unit for receiving details of the user operation detected by the script, and transmitting the details to an external server device,

wherein, when a cursor position is received from the script as the details of the user operation, the user operation information transmission unit transforms the cursor position that the script has acquired into a cursor position with respect to a reference position on a screen and transmits the cursor position to the server device.

(2)

The information processing apparatus according to (1) described above, wherein the details of the user operation detected by the script are a scroll of the content by the user.

(3)

The information processing apparatus according to (1) or (2) described above, wherein the details of the user operation detected by the script are a loading of another piece of content by the user.

(4)

The information processing apparatus according to any of (1) to (3) described above, wherein the details of the user operation detected by the script are a change of a render size of the content by the user.

(5)

The information processing apparatus according to any of (1) to (4) described above, wherein the content is a Web page.

(6)

The information processing apparatus according to (5) described above, wherein, when a cursor position is received from the script as the details of the user operation and if the cursor position acquired by the script is not on a top level frame of the Web page, the user operation information transmission unit transforms the cursor position into a cursor position on the top level frame of the Web page and transmits the cursor position to the server device.

(7)

An information processing apparatus including:

an operation details reception unit for receiving from a server device details of an operation, by a user who directly operates content, on content of the user; and

a content display unit for reflecting operation details received by the operation details reception unit in display of content same as the content displayed at a device operated by the user, and performing display.

(8)

The information processing apparatus according to (7) described above, wherein the content display unit draws a mouse cursor that is manipulated by the user who directly operates content, on a layer for drawing a cursor that is provided overlapping the content.

(9)

The information processing apparatus according to (7) or (8) described above, wherein the details of a user operation received by the operation details reception unit are a scroll of the content by the user.

(10)

The information processing apparatus according to any of (7) to (9) described above, wherein the details of a user operation received by the operation details reception unit are a loading of another piece of content by the user.

(11)

The information processing apparatus according to any of (7) to (10) described above, wherein the details of a user operation received by the operation details reception unit are a change of a render size of the content by the user.

(12)

The information processing apparatus according to any of (7) to (11) described above, wherein the content is a Web page.

(13)

A server device including:

an operation details reception unit for receiving from a device monitoring an operation, by a user who directly operates content, on content of the user details of the operation; and

an operation details relay unit for transmitting the details of the operation to every device logged in a system except for a transmission source.

(14)

An information processing method including:

injecting a script for monitoring an operation, by a user who directly operates content, on content of the user into the content, and communicating with the script injected into the content; and

receiving details of the user operation detected by the script, and transmitting the details to an external server device,

wherein, in the step of receiving and transmitting, when a cursor position is received from the script as the details of the user operation, the cursor position that the script has acquired is transformed into a cursor position with respect to a reference position on a screen before being transmitted to the server device.

(15)

A computer program for causing a computer to perform:

injecting a script for monitoring an operation, by a user who directly operates content, on content of the user into the content, and communicating with the script injected into the content; and

receiving details of the user operation detected by the script, and transmitting the details to an external server device,

wherein, in the step of receiving and transmitting, when a cursor position is received from the script as the details of the user operation, the cursor position that the script has acquired is transformed into a cursor position with respect to a reference position on a screen before being transmitted to the server device.

(16)

A content sharing system including:

a plurality of first information processing apparatuses operated by users who directly operate content;

at least one second information processing apparatus that is used to view the content that is operated by the first information processing apparatuses; and

a server device for relaying between the first information processing apparatuses and the second information processing apparatus,

wherein the first information processing apparatuses each include
a script management unit for injecting a script for monitoring an operation, by a user who directly operates content, on content of the user into the content, and communicating with the script injected into the content, and
a user operation information transmission unit for receiving details of the user operation detected by the script, and transmitting the details to the server device,
wherein, when a cursor position is received from the script as the details of the user operation, the user operation information transmission unit transforms the cursor position that the script has acquired into a cursor position with respect to a reference position on a screen and transmits the cursor position to the server device,

wherein the server device includes
an operation details reception unit for receiving from a device monitoring an operation, by a user who directly operates content, on content of the user the operation details, and
an operation details relay unit for transmitting the operation details to every device logged in the system except for a transmission source, and

wherein the second information processing apparatus includes
an operation details reception unit for receiving from the server device details of an operation, by a user who directly operates content, on content of the user, and
a content display unit for reflecting operation details received by the operation details reception unit in display of content same as the content displayed at a device operated by the user, and performing display.

The present application contains subject matter related to that disclosed in Japanese Priority Patent Application JP 2011-107401 filed in the Japan Patent Office on May 12, 2011, the entire content of which is hereby incorporated by reference.

What is claimed is:

1. An information processing apparatus comprising:
a script management unit for injecting a script for monitoring an operation, by a user who directly operates content, on content of the user into the content, and communicating with the script injected into the content; and
a user operation information transmission unit for receiving details of the user operation detected by the script, and transmitting the details to an external server device,
wherein, when a cursor position is received from the script as the details of the user operation, the user operation information transmission unit transforms the cursor position that the script has acquired into a cursor position with respect to a reference position on a screen and transmits the cursor position to the server device.

2. The information processing apparatus according to claim 1, wherein the details of the user operation detected by the script are a scroll of the content by the user.

3. The information processing apparatus according to claim 1, wherein the details of the user operation detected by the script are a loading of another piece of content by the user.

4. The information processing apparatus according to claim 1, wherein the details of the user operation detected by the script are a change of a render size of the content by the user.

5. The information processing apparatus according to claim 1, wherein the content is a Web page.

6. The information processing apparatus according to claim 5, wherein, when a cursor position is received from the script as the details of the user operation and if the cursor position acquired by the script is not on a top level frame of the Web page, the user operation information transmission unit transforms the cursor position into a cursor position on the top level frame of the Web page and transmits the cursor position to the server device.

7. An information processing apparatus comprising:
an operation details reception unit for receiving from a server device details of an operation, by a user who directly operates content, on content of the user; and
a content display unit for reflecting operation details received by the operation details reception unit in display of content same as the content displayed at a device operated by the user, and performing display.

8. The information processing apparatus according to claim 7, wherein the content display unit draws a mouse cursor that is manipulated by the user who directly operates content, on a layer for drawing a cursor that is provided overlapping the content.

9. The information processing apparatus according to claim 7, wherein the details of a user operation received by the operation details reception unit are a scroll of the content by the user.

10. The information processing apparatus according to claim 7, wherein the details of a user operation received by the operation details reception unit are a loading of another piece of content by the user.

11. The information processing apparatus according to claim 7, wherein the details of a user operation received by the operation details reception unit are a change of a render size of the content by the user.

12. The information processing apparatus according to claim 7, wherein the content is a Web page.

13. A server device comprising:
an operation details reception unit for receiving from a device monitoring an operation, by a user who directly operates content, on content of the user details of the operation; and
an operation details relay unit for transmitting the details of the operation to every device logged in a system except for a transmission source.

14. An information processing method comprising:
injecting a script for monitoring an operation, by a user who directly operates content, on content of the user into the content, and communicating with the script injected into the content; and
receiving details of the user operation detected by the script, and transmitting the details to an external server device,
wherein, in the step of receiving and transmitting, when a cursor position is received from the script as the details of the user operation, the cursor position that the script has acquired is transformed into a cursor position with respect to a reference position on a screen before being transmitted to the server device.

15. A computer program for causing a computer to perform:
injecting a script for monitoring an operation, by a user who directly operates content, on content of the user into the content, and communicating with the script injected into the content; and
receiving details of the user operation detected by the script, and transmitting the details to an external server device,
wherein, in the step of receiving and transmitting, when a cursor position is received from the script as the details of the user operation, the cursor position that the script has acquired is transformed into a cursor position with respect to a reference position on a screen before being transmitted to the server device.

16. A content sharing system comprising:
a plurality of first information processing apparatuses operated by users who directly operate content;
at least one second information processing apparatus that is used to view the content that is operated by the first information processing apparatuses; and
a server device for relaying between the first information processing apparatuses and the second information processing apparatus,
wherein the first information processing apparatuses each include
a script management unit for injecting a script for monitoring an operation, by a user who directly operates content, on content of the user into the content, and communicating with the script injected into the content, and
a user operation information transmission unit for receiving details of the user operation detected by the script, and transmitting the details to the server device,
wherein, when a cursor position is received from the script as the details of the user operation, the user operation information transmission unit transforms the cursor position that the script has acquired into a cursor position with respect to a reference position on a screen and transmits the cursor position to the server device,
wherein the server device includes
an operation details reception unit for receiving from a device monitoring an operation, by a user who directly operates content, on content of the user the operation details, and
an operation details relay unit for transmitting the operation details to every device logged in the system except for a transmission source, and
wherein the second information processing apparatus includes
an operation details reception unit for receiving from the server device details of an operation, by a user who directly operates content, on content of the user, and
a content display unit for reflecting operation details received by the operation details reception unit in display of content same as the content displayed at a device operated by the user, and performing display.
